(19) United States
(12) Patent Application Publication
(10) Pub. No.: US 2003/0120593 A1
(43) Pub. Date: Jun. 26, 2003

(54) Method and system for delivering multiple services electronically to customers via a centralized portal architecture

(75) Inventors: Amar Inder Singh Bansal, Union City, CA (US); Armen Beylerian, Alameda, CA (US); Vincent Cross, Allen, TX (US); Michael H. Lloyd Davies, El Cerrito, CA (US); Eric Cheukfung Lam, South San Francisco, CA (US); Michael Manowski, San Francisco, CA (US); Timothy William Oborne, South San Francisco, CA (US); Paul J. Orleman, Daly City, CA (US); Hector Reyes JR., Foster City, CA (US); Christopher von See, Garland, TX (US); Nahendran Srinivasan, Union City, CA (US); John Tsang, Sunnyvale, CA (US); Ronald T. Welf, Montara, CA (US); Rebeccah James, Allen, TX (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Visa U.S.A., San Francisco, CA

(21) Appl. No.: 10/222,761

(22) Filed: Aug. 15, 2002

Related U.S. Application Data
(60) Provisional application No. 60/312,698, filed on Aug. 15, 2001.

(51) Int. Cl. G06F 17/60

(52) U.S. Cl. 705/39; 705/36

(57) ABSTRACT

A system for facilitating handling of credit card transactions is provided. The system is made up of a number of components representing different functional areas including presentation framework, application components, application servers, asset management, data management, enterprise application integration, auxiliary services management, and performance management. In one application, the system is utilized by a credit card association to help facilitate processing of credit card transactions. The system provides a platform and associated functionality upon which various types of applications relating to credit card transaction processing can be implemented and executed.

### CROSS-REFERENCES TO RELATED APPLICATION(S)

The present application claims the benefit of priority under 35 U.S.C. §119 from U.S. Provisional Patent Application Serial No. 60/312,698, entitled “METHOD AND SYSTEM FOR DELIVERING MULTIPLE SERVICES ELECTRONICALLY TO CUSTOMERS VIA A CENTRALIZED PORTAL ARCHITECTURE” filed on Aug. 15, 2001, the disclosure of which is hereby incorporated by reference in its entirety for all purposes.

### BACKGROUND OF THE INVENTION

The present invention generally relates to a system for use in connection with handling credit card transactions. More specifically, the present invention relates to a system that is capable of delivering multiple services to various users involved in the processing of credit card transactions.

The use of a credit card has greatly facilitated commercial transactions, at least from a credit card holder's perspective. A credit card holder is able to complete a transaction with a merchant without having the requisite amount of cash available. All the credit card holder needs to do is to present his/her credit card to the merchant to allow the merchant to charge the amount of the transaction to the credit card holder's account. The credit card holder is then periodically billed by the credit card issuer for charges made. While a credit card transaction may seem simple from the credit card holder's point of view, the logistics and details that go into a successful credit card transaction are far from simple.

Other parties are involved in a typical credit card transaction. In addition to the credit card holder, there are the credit card issuers who issue the credit cards to the credit card holders, the merchants who agree to accept credit cards as a form of payment, the acquirers who contract with the merchants to handle their credit card transactions, and credit card membership associations, like VISA and Mastercard, who provide the necessary payment processing networks and resources to allow credit card transactions to be processed amongst the various parties. Each of these different parties evidently performs a different function or role in a credit card transaction. Hence, they all require different types of services in order to allow them to perform their respective functions. Typically, different and separate systems are used to provide the various types of services needed by these different parties. Therefore, it would be desirable to provide an integrated system which is capable of offering and delivering various types of services which meet the specific needs of each of the parties involved in a credit card transaction.

### SUMMARY OF THE INVENTION

A system for facilitating handling of credit card transactions is provided. In one exemplary embodiment, the system is made up of a number of components representing different functional areas including presentation framework, application components, application server, asset management, data management, enterprise application integration, auxiliary services management, and performance management.

Presentation Framework

The presentation framework is responsible for performing several major functions including:

establishing the communications protocols used between a third party system and the outside world, both for user-level interactions and for automated or semi-automated business-to-business communications

performing the conversion from the structured data generated by system-based applications to presentation formats that are appropriate for the target user and communications protocol, and ensuring that the presentation format is consistent across all system-based applications

handling unsolicited inbound communications (fax, e-mail, SMS or voice, for example) and routing the communications to either an appropriate destination or to a pre-defined business workflow for processing

transforming outbound syndicated content to the appropriate presentation format based on a user's preferred protocol

allowing user interface customization (fonts, layout, colors, and so on)

The presentation framework further includes a number of services or components including web Servers, portals, and multi-channel gateways.

Web servers provide access to applications using the HTTP protocol. Typically, interactions through web servers are performed using HTML and XML, although it is possible to deliver a wide range of text and binary media such as Flash, Shockwave, Real Media, and others.

For users interacting with the system via HTTP and HTML, an application portal provides an easy-to-use, customizable and consistent mechanism through which these users can access they applications they need.

The multi-channel gateways are responsible for providing transmission and/or presentation protocol support for system clients. The possible protocols include WAP (with the WML presentation markup language), voice, fax, e-mail (in text or HTML format), FTP and Short Messaging Service (SMS) text. While many user interactions such as those provided by HTTP/HTML are “request-response”, it is also possible for unsolicited interactions to arrive at the multi-channel gateways through protocols such as voice, e-mail, or FTP. In this case, the gateways provide a mechanism for routing this traffic to its ultimate destination using either simple redirection or routing through a workflow process.

Application Components

The application components subsystem spans a wide range of potential applications and application-related services, used by both programs running in the system and directly by users through the presentation framework. By its very nature, this subsystem has the greatest potential for extension of all the system services as new technologies and products emerge and are included into the system architecture as additional application components are added due to ongoing development activities and business requirements. The application components provide functionality in a number of areas including, collaboration, imaging, reporting, search, registration, e-commerce, workflow and subscription management.

Collaboration

The need for collaboration among internal users and between internal users and external users of applications and services is expected to grow substantially as the transaction volume increases. At its most basic level, collaboration can be accomplished using tools such as e-mail, chat, and newsgroups; future opportunities for collaboration include facilities such as shared workspaces and collaborative content development.

In addition to the bi-directional, user-oriented collaboration mechanisms mentioned above, there is also the opportunity for organizational collaboration, in the form of distributed business processes and business-to-business data exchange. Sometimes, this collaboration is one-way: one partner transfers a file to another partner, resulting in some number of transactions at the destination. In other cases, the collaboration can take place in both directions, and multiple interactions may be required in order to complete a single business operation. It is also possible that an organization like Visa can use its extensive infrastructure investment and status as a trusted business partner to function as an intermediary between member banks, merchants or even card holders.

Imaging

Given the number and nature of the transactions an organization may handle, imaging is a key technology to support consistent storage and retrieval of transaction-related information, especially when disputes are involved. Imaging technologies facilitate the handling and management of large amounts of paper and other materials, especially where rapid search and semi-permanent storage is required. The system defines standardized support for image creation, image storage, backup and restore, search (using metadata or, in cooperation with optical character recognition, by content as well), and online display of imaged materials straight to the desktop.

Reporting

Reporting is an important area of business operations for most organizations, supporting the consolidation, analysis and review of extremely large quantities of business data. The system's reporting facilities interact heavily with the components of the data management subsystem, as further described below. The approach used by the system to provide reporting services is to supply a number of centralized reporting servers running software which enables pre-defined or ad-hoc reports to be run in real time or on a scheduled basis. These servers also perform authorization of users to both the reporting tools themselves and to the data upon which reports can be run. Output can be viewed from anywhere in a network through an HTTP connection.

Search

Internet users have come to consider search to be an integral part of any web-based application. The system's search capabilities allow both metadata-based search and, for certain resources, full text search as well. The use of a consistent extensive metadata tag set across all resources helps ensure that users can find the information they want using criteria that are appropriate for the resources being searched.

In addition to the search engine itself, this component provides the facilities to index content and assign metadata. As searchable content or documents are created, they are assigned keywords by the originator; these keywords are then stored as metadata for use in search operations. If full text search is desired, the information is submitted to an indexing engine; the index is stored in a central location for use by all full-text search operations. Restrictions on search capabilities and content to be searched can be imposed based on the originator of the content or document, the roles and permissions of the person issuing the search request, and security and resource usage policies.

Registration

Registration facilities are important to many different aspects of the overall system architecture. In addition to gathering information about users, an effective registration process can, among other things:

Provide data for user interface personalization, allowing appropriate, relevant content to tailored to a user's individual needs

Facilitate the assignment of user roles and permissions

Reduce administrative work by allowing users to register or un-register themselves, or provide their own user profile management

Enable delegated administration by allowing personnel at member banks or other parts of the network to register users on behalf of their respective organizations

Provide important information to applications for use in transaction tracking, audit trails and access logging

The system provides a consistent approach to registration. The approach provides common tools to gather appropriate data for a given user and to route that data through one or more workflows that are customized based on organizational unit, geographic location, security level, or other guidelines. Registration data is stored in the directory service where it is accessible to all security services and applications.

E-Commerce

Participation in a transaction process implies a close linkage of c-commerce services. Anytime a party is involved in a transaction process, there are opportunities to offer e-commerce services. Consequently, c-commerce services are included as part of the system 10. The types of e-commerce services included in the system 10 depend on the needs of the users. In one exemplary embodiment, the c-commerce services are provided based on applications utilized by a credit card association, such as, Visa.

Workflow

Workflow is the routing of data through a series of steps in a business process that results in a finished task. A given business process workflow can be as simple or as complex as desired, with capabilities ranging from the simple execution of a sequence of steps to complex routing based on business rules, input data, user profile, and a host of other factors.

Most workflow engines provide the ability for steps in a business process to be performed by a combination of humans and automated agents across any number of geographies and time zones, providing even more flexibility in process execution. Steps can be assigned to an individual, a group of individuals, or to a pool of workers. Assigned tasks appear in a task list owned by the assigned individual or group, and the assigned worker(s) are notified of the task via e-mail or another appropriate mechanism. The task list can be accessed through standard HTTP facilities, allowing the assigned individual or group to work on the task from anywhere. If a key task owner is unavailable, workflow administrators can reassign the task to another capable individual.

Subscription Management

It is often appropriate for users to be able to subscribe to notifications of new content or to changes in existing content. This content can take many forms, ranging from simple HTML page fragments to complex business documents; even the output of applications and services can be subscribed to complementing the organization's collaboration capabilities by keeping members abreast of new developments.

Subscription to content and services can be done through a service that leverages information already gathered during the registration process. Users can view a list of available subscriptions that is tailored to their security profile, and may subscribe or unsubscribe themselves, be enrolled by others or have subscriptions created automatically.

Application Server

The application server provides the key underpinnings of application development within the system. The application server forms the core of the system architecture from the application's perspective. The application server provides a number of functionality including application runtime, personalization, authentication, authorization and sign-on, directory and naming and certification management.

Application Runtime

The application runtime component provides a common execution environment and related services for the applications developed using the system architecture. The application runtime covers three aspects of application development:

The application runtime environments to be used by the various programming languages supported by the system

Complementary tool sets (graphics and windowing libraries, XML utilities, and so on)

Specifications to be used when certifying other system components for use with the application runtime and/or when certifying new programming languages for use with existing system components

For Java and Java 2 Enterprise Edition (J2EE) applications, implementation of this component would define the supported Java Runtime Environments (JREs), J2EE application servers and complementary tool libraries across a suite of applications developed with the system architecture. For Microsoft .Net applications the runtime environment would include certified Microsoft product releases and complementary tool libraries on each of the system platforms.

The certification of application runtime environments is an important aspect of this component. Application runtime environments such as those for Java change on a regular basis, they cannot be introduced into the system environment without first certifying that they can be used successfully with the other key system components. A new JRE or C++ runtime, for example, is certified for use with components such as:

System security facilities, including digital certificate tools, encryption, and directory services interfaces

The Enterprise Application Integration (EAI) tools, and in particular the language-specific stubs used to access messaging and data transformation services

The application programming interfaces (APIs) for vendor products such as content management, workflow and eCommerce services

Cross-language communication, including that provided by the Java Native Interface (JNI) facility

Certification of new runtime environments provides the application developer with a level of confidence that they may use the new environment without encountering cross-product or cross-language compatibility issues.

Personalization

Personalization provides system applications with the ability to tailor their interactions with end users such that the user perceives the maximum value from the application interaction. In many cases, personalization is accomplished through a combination of user interaction tracking (clickstream analysis, for example), preferences expressed by the user (through registration, for example) and directives imbedded in applications that leverage this information to tailor their output to the particular user being served.

Authentication, Authorization and Single Sign-On

The authentication, authorization and single sign-on component provides the critical facilities for verifying the identify of a given entity, determining what applications and services they should have access to, and simplifying their interactions by coordinating authentication and authorization across all system-based systems. This component uses the directory component to store all of the information required to perform these tasks.

The authentication capabilities of this component are very flexible and are both based on specific application needs and insulated from those applications. Applications with low or moderate security needs can rely on userid-password or digital certificate authentication, while higher-security applications can use smart cards, biometrics or some other mechanism; the exact facility used is transparent to the applications themselves.

The roles- and permission-based authorization structure provides maximum flexibility to applications. Using this information, the single sign-on tool can deny application access completely or provide access to only selected portions of the application. The roles and permissions allocated to a given user can also be passed to the application for finer-grained control over data access (allowing access to data from only one region, for example) and/or the ability to perform certain application-specific operations (such as data updates).

Directory and Naming

The directory component provides a hierarchical mechanism for storing and retrieving information about any entity, whether it be a user of applications and services, the applications and services themselves, or components of a network infrastructure. The structure is very flexible, and attributes can be added, removed or changed in a very straightforward fashion.

The naming component serves as the translation mechanism for names assigned to entities in an organization. Computers, networked resources, applications and services can all be named; by allowing access only by name, these resources can be physically moved or reconnected with no impact on applications or users that use them.

Certificate Management

The certificate management functions take on the important role of managing digital certificates assigned to users, applications and services. These digital certificates can be used to both authenticate users and to encrypt data exchanged with these users such that only the intended user can decrypt it.

Certificate management is typically performed using certificate servers. When a certificate is created it is stored in one or more servers, where it can be retrieved as needed for data encryption. When an employee leaves an organization, the certificate can be revoked by administrators at the server, preventing its future use.

Data Management

The data management subsystem provides services that enable the comprehensive, effective use of an organization's data assets. Users do not typically access the data assets directly. Rather, they are provided access to the appropriate data (based on their roles and permissions) through applications and services, including both applications created in-house and packaged applications purchased through third-party vendors.

Data Warehouse

A data warehouse is a repository of integrated information, which is extracted from heterogeneous sources and stored in the data warehouse as it is generated. Because the data is pre-extracted and pre-integrated, data queries and analysis are much easier and more efficient.

Data typically passes through a two step process on its way from the various sources to the data warehouse. In most organizations, there is a single large repository called an “operational data store” (ODS) which is used to aggregate and integrate data, and often serves as an up-to-the-minute picture of all an organization's operational data. Detailed data is extracted from the applications, transformed and cleansed, and placed into the ODS; then, data used in decision support and analysis is extracted from the ODS and stored in the data warehouse in an optimized format. In most cases, more focused subsets of the data are extracted from the data warehouse and stored in department- or group-level data stores, called “data marts”. These data marts can be created at any level—from larger regional data marts to departmental data marts—and serve to support more focused reporting, business intelligence and analytical processing.

The system supports the creation and maintenance of an ODS, data warehouse and data marts by recommending both an underlying relational data store and complementary tools to enable the creation and maintenance of these repositories.

Asset Management

The asset management subsystem controls the production and management of content and documents. There are two different components in this subsystem: the content management component, which controls web-based content and delivery channels, and document management, which controls the production of documents.

Content Management

The content management component is responsible for providing services that assist with authoring, editorial workflow, change management and access auditing, publication and expiration, and versioning of content.

Document Management

Just as the content management component handles many common tasks for content items, the document management component is responsible for providing those same services for documents.

Enterprise Application Integration (EAI)

The enterprise application integration subsystem provides reliable, expandable, and secure application interactions using a number of communication protocols. The exact mechanism to be used to communicate with a given application or service is hidden by the use of integration layers, which provide an abstract means for requesting services. The EAI includes a number of components including legacy gateways, messaging and integration adapters, transaction processing systems, publish/subscribe service and CORBA.

Legacy Gateways

The legacy gateways provide access to legacy systems, such as VTRS. The exact communications methods to be supported in the gateways depend on the applications targeted. Possible solutions include “screen scraping” software, messaging middleware, direct database access, distributed transactions performed using CORBA, a J2EE application server and/or transaction processing monitor.

Messaging and Integration Adapters

The system's messaging and message transformation facilities provide a robust means for integrating the various applications and services. The combination of point-to-point (direct communications between two applications) and “publish/subscribe” (publishing of messages on a “topic” which is accessible by multiple listeners) provides great flexibility in processing models. Location transparency, another aspect of the system's messaging implementation, allows applications and services to be moved or replicated without impacting communications, and guaranteed message delivery ensures that critical requests are received even if the system to receive them is not available.

The system's messaging layer also supports transformation, or the restructuring of data as it is being passed from one application to another. This allows changes to be made in one application without affecting other applications by incorporating transformation rules outside of the applications themselves that restructure data or limit the scope of data transmitted.

Transaction Processing Systems

Transaction processing systems such as CICS, IMS/DC and Tuxedo have long been the workhorses of many organizations. Over time, these systems have been enhanced to support interaction with external systems through messaging, transaction routing, and gateways, making them important parts of an overall legacy systems integration strategy.

Publish/Subscribe Service

The “publish/subscribe” messaging model is used as a mechanism to make multiple applications aware of critical business events. In this model, an application creates a “business event” (message), and then publishes it to a “topic”. Applications interested in business events on a given topic will receive the event when it is published and can take appropriate action. The communications mechanisms used to transmit these events are capable of supporting many publishers and subscribers with redundant, fault-tolerant and guaranteed delivery services.

CORBA

CORBA automates many common network programming tasks, such as, object registration, location, and activation; request demultiplexing; framing and error-handling; parameter marshalling and demarshalling; and operation dispatching. There are many ways to use CORBA. In one exemplary embodiment, COBRA is used within the system as a transport service for communication with legacy systems.

Auxiliary Services

The auxiliary services subsystem includes common facilities that can be shared across all applications within the system. The auxiliary services subsystem provides a number of services including audit trail and logging and scheduler services.

Audit Trail and Logging

The system provides for the creation of central audit logs containing transaction data which would normally be spread across several architectural components, applications or services. The most obvious benefit of a centralized audit trail is in retrieval; by aggregating and/or correlating data for the same operation provided by different subsystems, the research required to review the processing performed for a given operation or determine the cause of a mishandled transaction is substantially reduced. The system's audit trail facilities include mechanisms for backup and recovery using time-based criteria, search facilities which support a range of qualifying criteria, and a common data display function.

The system's audit trail facilities are supported by its centralized and distributed logging systems, which allow data to be logged by or for applications, services and commercial packages. By providing a common logging facility, system applications can log data locally and/or have critical application data sent to the centralized audit log.

Scheduler

The scheduling service allows applications or services to schedule one-time or repetitive tasks to be executed in the future. The scheduling service is distributed, meaning that tasks can be scheduled into an environment which has the appropriate access to the necessary data and tools. The application scheduling a task has the option of explicitly specifying the machine on which a scheduled task is to run.

Performance

The performance subsystem provides facilities to monitor and enhance the performance of the system and the applications and services it supports. The performance subsystem provides a number of services including performance monitoring and performance enhancement.

Performance Monitoring

The performance monitoring component gathers important performance data from all layers of the system architecture—hardware, operating system, database, network, and applications and services. This data can then be used not only to detect and resolve bottlenecks in the architecture and its supported applications, but to perform capacity planning as well.

Performance Enhancement

Performance improvement in networked applications is sometimes possible through the use of techniques that are independent of the applications being served. The performance enhancement component of the system is intended to exploit these techniques with minimal impact to applications and services. Possible candidates for improvements that fall into this category include: caching, which includes both the use of local caching mechanisms (such as proxy servers) as well as networked servers and content assembly services; selective relocation or replication of services to network access points close to critical users; local and distributed load balancing strategies, both hardware- and software-based.

Reference to the remaining portions of the specification, including the drawings and claims, will realize other features and advantages of the present invention. Further features and advantages of the present invention, as well as the structure and operation of various embodiments of the present invention, are described in detail below with respect to accompanying drawings, like reference numbers indicate identical or functionally similar elements.

### BRIEF DESCRIPTION OF THE DRAWINGS

FIG. 1 is a simplified block diagram illustrating the logical architecture of an exemplary embodiment of a system in accordance with the present invention;

FIG. 2 is a simplified block diagram representing a basic component interaction model of a web server serving static content from a file server;

FIG. 3 is a simplified block diagram illustrating an XML/XSL architecture;

FIG. 4 is a simplified block diagram illustrating an exemplary architecture of a voice channel;

FIG. 5 is a simplified block diagram illustrating an exemplary wireless architecture;

FIG. 6 is a simplified block diagram representing a basic component interaction model between a web server, a WAP gateway and a WAP client;

FIG. 7 is a simplified block diagram illustrating how an e-mail is sent through a mail server using SMTP protocol;

FIG. 8 is a simplified block diagram representing a basic component interaction model illustrating how an image is captured and stored into a database;

FIG. 9 is a simplified block diagram illustrating creation of an image;

FIGS. 10 and 11 are simplified block diagrams illustrating two respective scenarios in which the imaging service is integrated with other applications;

FIG. 12 is a simplified block diagram illustrating an exemplary reporting system;

FIG. 13 is a simplified block diagram illustrating an exemplary workflow architecture;

FIG. 14 is a simplified block diagram illustrating an exemplary architecture of the data management subsystem;

FIG. 15 is a simplified block diagram representing a basic component interaction model illustrating how the data warehouse is populated;

FIG. 16 is a simplified block diagram representing a basic component interaction model illustrating how a data request is satisfied;

FIG. 17 is a simplified block diagram illustrating an exemplary ETL architecture;

FIG. 18 is a simplified block diagram illustrating an exemplary architecture of a messaging service system;

FIG. 19 is a simplified block diagram illustrating an exemplary architecture of publish/subscribe service;

FIG. 19, there is shown a simplified block diagram illustrating an exemplary architecture of publish/subscribe service;

FIG. 20 is a simplified block diagram illustrating an exemplary architecture of the notification service;

FIG. 21 is a simplified block diagram illustrating an exemplary architecture of the transaction processing service;

FIG. 22 is a simplified block diagram illustrating an exemplary architecture of an EAI framework;

FIG. 23 is a simplified block diagram illustrating components of a CORBA architecture;

FIG. 24 is a simplified block diagram illustrating how CORBA is used as transport in integration with legacy systems;

FIG. 25 is a simplified block diagram illustrating an exemplary architecture of the legacy gateway service;

FIG. 26 is a simplified block diagram illustrating an exemplary architecture of the VTRS service;

FIG. 27 is a simplified block diagram illustrating an exemplary architecture of the audit trail service;

FIG. 28 is a simplified block diagram illustrating an exemplary architecture of the logging service;

FIG. 29 is a simplified block diagram illustrating an exemplary architecture of a scheduling system; and

FIG. 30 is a simplified block diagram illustrating an exemplary physical implementation of the system in accordance with the present invention.

### DETAILED DESCRIPTION OF THE INVENTION

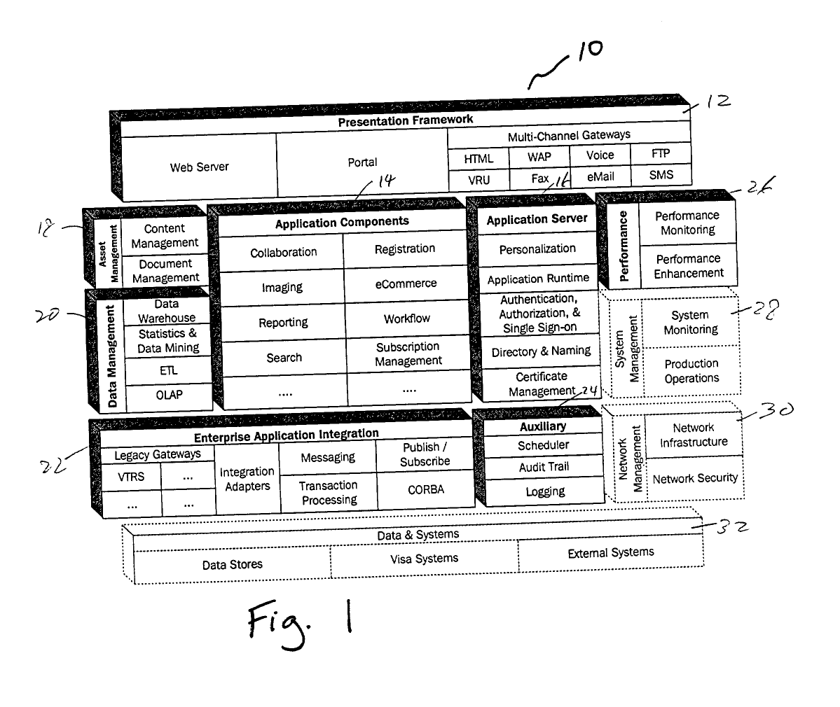

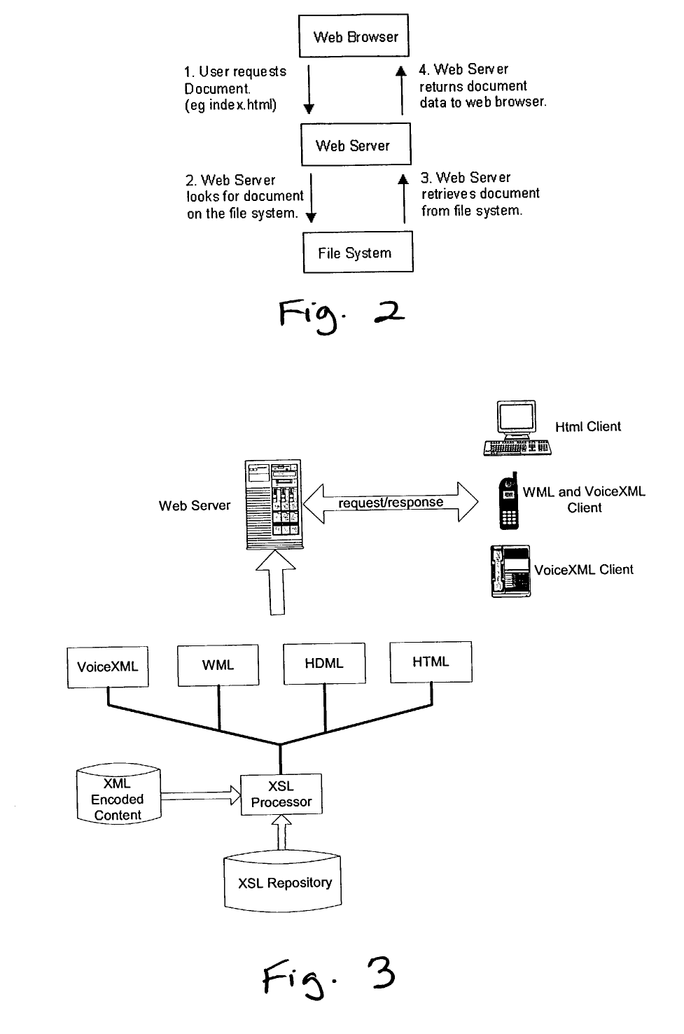

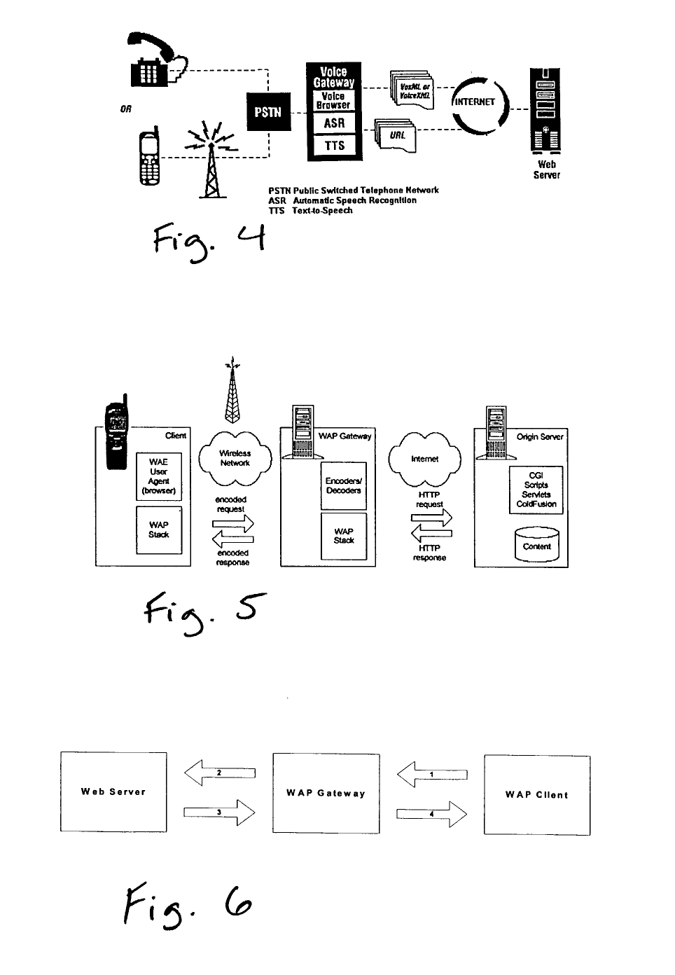

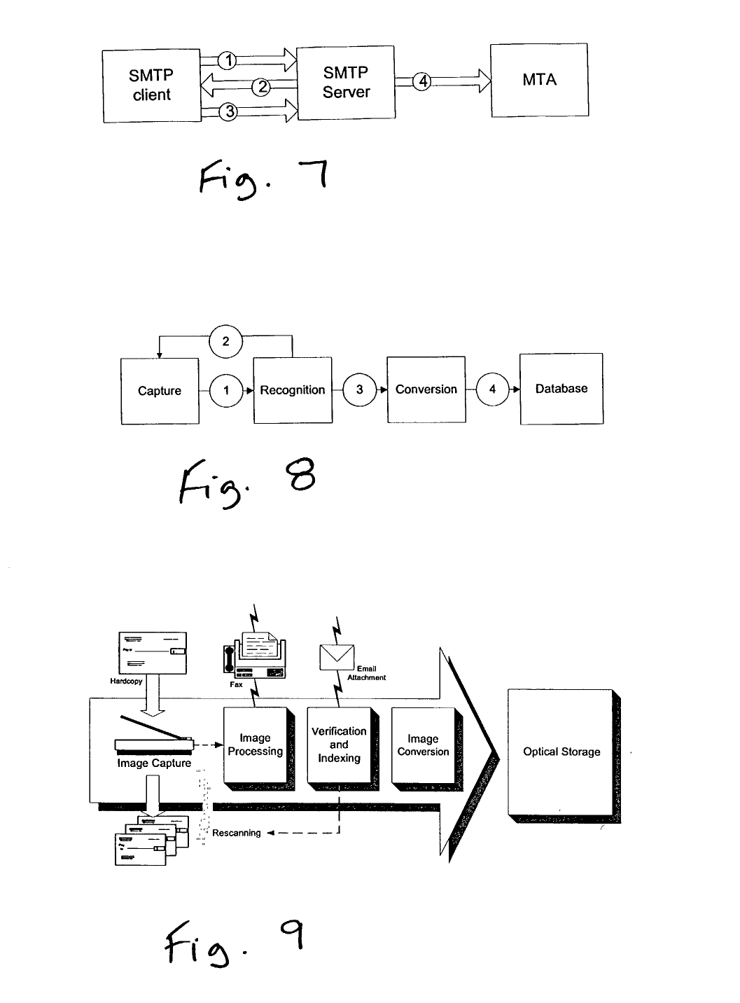

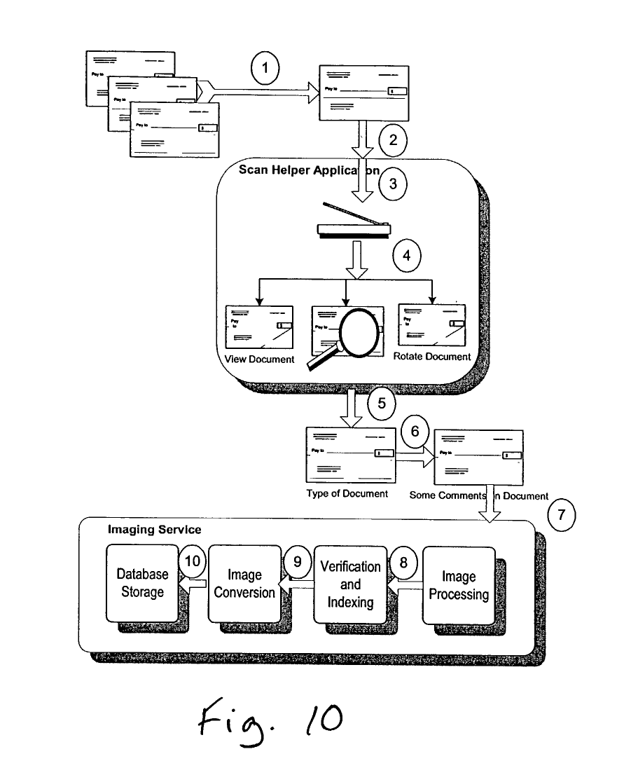

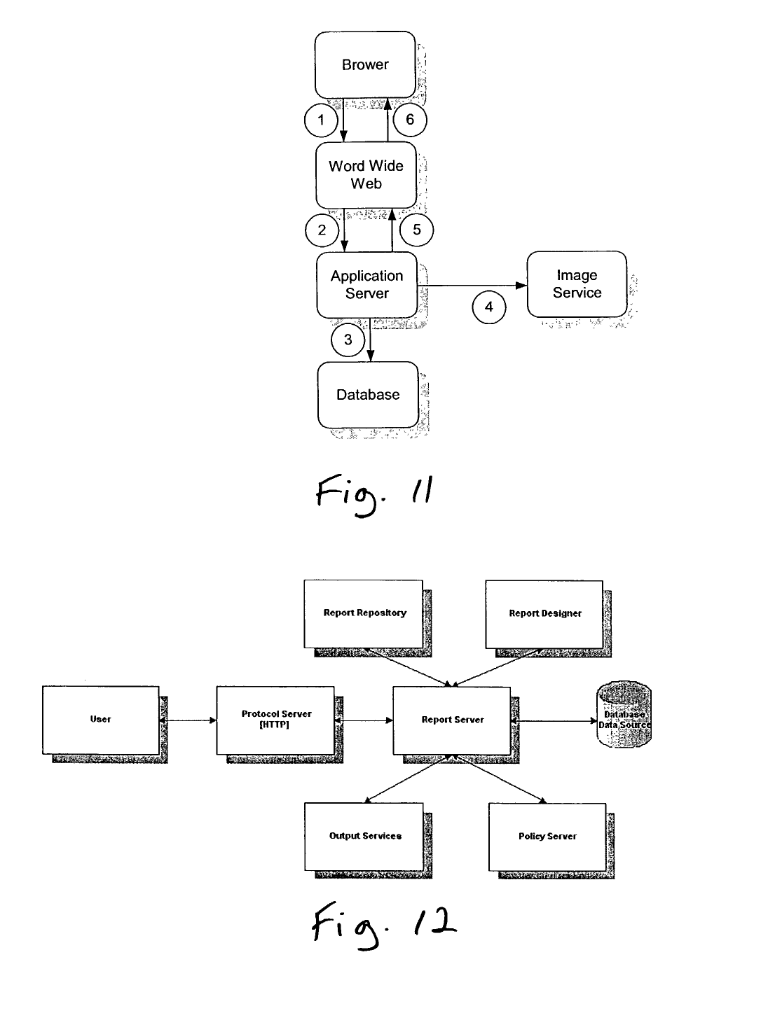

The present invention in the form of one or more exemplary embodiments will now be described. Referring to FIG. 1, there is shown the logical architecture of an exemplary embodiment of a system 10 in accordance with the present invention. The system 10 is made up of a number of components representing different functional areas including presentation framework 12, application components 14, application server 16, asset management 18, data management 20, enterprise application integration 22, auxiliary services management 24, and performance management 26, each of which will be further described below. The system 10 is capable of offering various categories of functionality and/or services including, for example, presentation framework services, application components services, application server services, asset management services, data management services, enterprise application integration services, auxiliary services and performance management services, each of which will be further described below. In addition, in one exemplary embodiment, the system 10 further interacts with other external systems to provide offer types of services including, for example, system management 28, network management 30 and external system and data management 32.

In one exemplary application, the system 10 is deployed by a credit card association, such as Visa, to implement and/or enhance various services and facilitate delivery of such services to its members.

Each of the components of the system 10 is now further described below.

1. Presentation Framework

Referring to FIG. 1, the presentation framework 12 is responsible for providing several major functions. For example, the presentation framework 12 establishes the communications protocols used between the system utilized by a credit card association and the outside world, both for user-level interactions and for automated or semi-automated business-to-business communications.

The presentation framework 12 also performs the conversion from the structured data generated by applications within the system 10 to presentation formats that are appropriate for the target user and communications protocol, and ensures that the presentation format is consistent across all applications within the system 10.

The presentation framework 12 further handles unsolicited inbound communications (for example, fax, e-mail, SMS or voice) and routes such communications to either an appropriate destination or to a pre-defined business workflow for processing.

In addition, the presentation framework 12 transforms outbound syndicated content to the appropriate presentation format based on a user's preferred protocol and allows user interface customization (fonts, layout, colors, and so on).

The presentation framework 12 uses a number of components to provide the various functions described above. These components include one or more web servers, portals and a number of multi-channel gateways, each of which will be further described below.

1.1 Web Servers

Web servers provide access to applications using the HTTP protocol. Typically, interactions through web servers are performed using HTML and XML, although it is possible to deliver a wide range of text and binary media such as Flash, Shockwave, Real Media, and others. Web servers' primary role is to establish the communication with a browser, or other http or WAP clients, deliver data, manage the exchange of data, manage delivery and retrieval of cookies, and provide an interface point for dynamic applications and back-end environments. Web servers are tuned for throughput of data, primarily static data retrieved from a file system, while application servers are tuned for CPU processing and database retrieval. If a web site's main objective is to provide access to static, or semi-static (i.e., not changing on an hourly basis, and can be pre-derived) content with minimal functionality or form activity, then the web server is preferably the predominant server component being used. Many web servers have the ability to process Java or ActiveX (.NET) script in the web container, in-process with the web server. FIG. 2 is a simplified block diagram representing a basic component interaction model of a web server serving static content from a file server.

In an exemplary implementation, a web server used in connection with the system 10 has the following characteristics. The web server is able to service HTTP requests. The bare minimum requirement defining a web server is its ability to listen for and service HTTP request for static content. The web server is also able to establish SSL (Secure Socket Layer) connections with clients using the HTTPS protocol. SSL is a tunneling protocol used to encrypt the payload of an HTTP communication.

Standard CGI capabilities are supported by the web server. CGI (Common Gateway Interface) is a standard for accessing programs and dynamic functionality, rather than static content files. CGI is a standard, not a language. CGI applications can be written in about any language, whether compiled or interpreted script, as long as they can accept input using Standard In and output data using Standard Out. The web server also supports plug-ins to extend the functionality of the web server. Plug-ins differ from CGI applications in the sense that they have the ability to intercept the request before it is processed by the web server, or modify the request after the request has been processed. Two common plug-in standards are NSAPI for IPlanet servers and ISAPI for Microsoft servers. The plug-ins typically are dynamic libraries loaded by the web server at runtime and execute in the web server's process context and memory space.

The web server is further able to integrate with other application servers through the use of supported plug-ins and extensions. The ability to integrate with other application servers allows additional applications and/or functionality to be made available.

The web server is also able to support load balancing. In doing so, the web server may work with external load balancing technologies, or provide its own software based load balancing capabilities.

The web server is able to maintain session state. In other words, the web server is able to keep track of a user session through the use of either cookies or URL rewriting, or both. Session state is useful both when developing web applications and analyzing log files.

The web server is able to restrict access to specific content, directories, and servers based on user authentication and group membership and support external directories for authentication. Using an external directory for user and group authentication allows for simplified administration (for example, a common authentication store between application servers and web servers may be maintained) and provides the basis for single sign-on.

The web server provides a graphical interface for remote administration. The web server is able to provide either a browser-based or desktop client for administering the web server remotely. The preferred alternative is a browser-based administrative, graphical console that can manage multiple servers from the same console.

The web server is able to support virtual servers. In other words, the web server is able to host multiple web sites (virtual servers), with their own respective web and application roots on the same server instance. Each site hosted as a virtual server is mapped to a separate IP address, has its own set of users and groups, and can be administered individually by separate administrators.

The web server further provides JAVA container and support for JSP and Servlets, either natively or via plug-in. That is, if the web server cannot support this natively, the web server then supports a plug-in for a separate application server or servlet engine.

Finally, the web server is able to support the latest HTTP protocol which currently is v1.1.

It should be understood that various types of web servers are offered by different commercial vendors. Some of the more popular web servers include, for example, Apache's open source HTTP server, Microsoft's IIS, and IPlanet's (formerly Netscape) Enterprise Web Server. Based on the disclosure provided herein, a person of ordinary skill in the art should be able to select and/or customize web servers that are commercially available for integration and use as part of the system 10 in accordance with the present invention.

1.2 Portals

For users interacting with the system 10 via HTTP and HTML, one or more portals are used to provide an easy-to-use, customizable and consistent mechanism through which these users can access the applications they need. A portal is a personalized secure web environment. The portal allows an organization to aggregate and share content-information, services, and applications with customers, partners, employees and suppliers. The portal can bring together technology, business processes, and business partners, enabling the organization to exchange information inside and outside the firewall. The portal also allows an organization to employ a single URL through which users receive customized and even personalized information, as well as vital business applications.

The objective of the portal is to aggregate services for the users so that they can be accessed at a single point. The access is based on an individual's authorization and is personalized to cater to that individual's need. At a minimum, the portal is able to present multiple content and applications to users, display a custom GUI to users, allow a user to configure the content and applications to access, perform access authorization on content and applications, and tailor content to users based on their individual characteristics or preferences.

It should be understood that there is no standard architecture for portal services. Various commercial products that address portal services are offered by different commercial vendors, with each product implementing its own design and functionality. Some of the commercial products that provide portal services include, for example, BEA WebLogic Personalization Server, Epicentric Portal Server, and iPlanet Portal Server. Based on the disclosure provided herein, a person of ordinary skill in the art should be able to select and/or customize portal products that are commercially available for integration and use as part of the system 10 in accordance with the present invention.

1.3 Multi-Channel Gateways

The multi-channel gateways are responsible for providing transmission and/or presentation protocol support for clients that interact with the system 10. Various protocols are supported by the multi-channel gateways including, for example, WAP (with the WML presentation markup language), voice, fax, e-mail (in text or HTML format), FTP and Short Messaging Service (SMS) text.

While many user interactions such as those provided by HTTP/HTML are “request-response”, it is also possible for unsolicited interactions to arrive at the multi-channel gateways through protocols such as voice, e-mail, or FTP. In this case, the multi-channel gateways provide a mechanism for routing this traffic to its ultimate destination using either simple redirection or routing through a workflow process.

Some of the protocols supported by the multi-channel gateways are further described below. Many channels of communication can take place over the Internet. These channels can be thought of as different mechanisms of delivery and the methods of interaction. There are numerous channels on the Internet such as the wireless-web and the voice-oriented web. As shown in FIG. 1, the system 10 integrates these channels and enables applications supported by the system 10 to interact with clients using these channels. A variety of devices are present that are able to access information using these channels. These devices include for example, wireless devices, such as PDAs, two-way pagers, mobile phones and other information appliances.

In one exemplary embodiment, the multi-channel gateways are designed to provide services to accommodate the following channels including: web channel, voice channel, wireless channel (WAP), e-mail channel, FTP channel, fax channel, VRU channel and SMS channel, each of which will be further described below.

1.3.1 Web Channel

The web channel is commonly understood by a person of ordinary skill in the art.

1.3.2 Voice Channel

The voice channel, listening to Internet information, gives content providers a new way to reach and expand their audience. Additionally, service providers are looking for new ways to drive revenue-adding subscribers and increase usage on their networks. Listening to Internet information is powerful because a user is only required to use a telephone and his/her voice. A user would have a telephone number s/he could use to dial a voice-Internet access service. This voice-Internet access service would provide the means to access certain content, via the Internet, by speaking and listening.

Referring to FIG. 4, there is shown a simplified block diagram illustrating an exemplary architecture of the voice channel. The voice channel functions as a liaison between a user calling in from virtually any phone and the vast content of the Internet. The voice gateway is a combination of computer servers that hold the voice browser software, the automatic speech recognition software, and the text-to-speech software to allow the access and running of voice applications.

The voice gateway server interprets voice commands and serves as a mediator between the telephony and Internet worlds, using speaker-independent voice recognition and text-to-speech (TTS) engines. On one side, the voice gateway serves as an interface to the Public Switched Telephone Network (PSTN)—determining the called number; on the other side the voice gateway communicates with the Internet using Internet protocols. Apart from using voice and audio for the user interface, the voice browser within the voice gateway behaves much like other web browsers when it interprets data from the Internet.

The voice browser software allows a user to call from virtually any phone and navigate through a voice driven application via voice menus or commands. The voice browser runs on behalf of the user and resides in the network or within the voice gateway thereby allowing access by any phone. The voice browser interacts with the user over a voice connection via the telephone network and with a web server. Using the voice browser, speech recognition and speech synthesis resources are available for use by the caller. Apart from using voice and audio for the user interface, the voice browser behaves much like other web browsers. The voice browser fetches data over the Internet using the web URL addressing scheme and HTTP protocol; the voice browser also optionally stores “cookies” on behalf of the user, and caches frequently accessed pages. The voice markup languages, such as VoxML and VoiceXML, function in a similar manner to HTML.

Speech recognition software recognizes voice commands. This speaker-independent system is easy to use because it recognizes most users' voices and most words without requiring the user to “train” the recognizer to distinguish their voice and special commands. Important considerations when evaluating speech recognition software capabilities include the ability to recognize the language or languages, such as Chinese and Spanish, and the ability to enable callers to quickly and easily use the system for things like voice activated dialing of phone numbers.

Text-to-speech technology translates each individual written word to a spoken word that listeners can hear. Some examples of where text-to-speech technology can be applied include news reports or e-mail, where the vocabularies are large and diverse thereby rendering pre-recording impractical.

It should be understood that various commercial products that address voice channels are offered by different commercial vendors, with each product implementing its own design and functionality. Some of the commercial products that are designed to handle voice channels include, for example, Motorola VoxGateway and VoiceGenie VoiceXML. A person of ordinary skill in the art should be familiar with the various technologies that are related to voice channels. Based on the disclosure provided herein, a person of ordinary skill in the art should be able to select and/or customize voice channel products that are commercially available for integration and use as part of the system 10 in accordance with the present invention.

1.3.3 WAP Channel

Wireless application protocol (WAP) is dedicated to the goal of enabling sophisticated telephony and information services on hand-held wireless devices such as mobile telephones, pagers, personal digital assistants (PDAs) and other wireless terminals. WAP provides a channel to offer compatible products and secure services on all devices and networks, resulting in greater economies of scale and universal access to information.

An exemplary WAP gateway includes the following functionality that facilitates communication between an origin server and mobile devices. Protocol translations between Internet protocols and the WAP protocol are designed to provide efficient and scaleable access to today's wireless networks. Furthermore, content encoders and decoders provide application and content efficiency. The WAP gateway encodes (compresses) WML content for more efficient use of the wireless network bandwidth by reducing the size and number of packets traveling over the network. The WAP gateway also compiles WML-script on behalf of the WAP browser relieving the browser from this process and CPU intensive task.

Referring to FIG. 5, there is shown a simplified block diagram illustrating an exemplary wireless architecture. The wireless application environment is based on the architecture used for WWW proxy servers. The situation where a user agent (e.g., a browser) is connected through a proxy to reach an origin server (i.e., the server that contains the desired content) is very similar to the case of a wireless device accessing a server through a gateway. WAP includes the Wireless Session Protocol (WSP) and Wireless Markup Language (WML). WSP is the WAP equivalent of HTTP and is based on HTTP/1.1. WSP is based on the concept of a request and a reply, each having a header and body. WML is the WAP equivalent of HTML.

Most connections between the browser and the WAP gateway use WSP, regardless of the protocol of the destination server. The URL, used to distinguish the desired content, specifies the protocol used by the destination server regardless of the protocol used by the browser to connect to the WAP gateway. In other words, the URL refers only to the destination server's protocol and has no bearing on what protocols may be used in intervening connections.

The browser communicates with the WAP gateway using WSP. The WAP gateway, in turn, would provide protocol conversion functions to connect to an HTTP origin server. In addition to performing protocol conversion by translating requests from WSP into other protocols and the responses back into WSP, the WAP gateway may perform content conversion.

The use of a WAP gateway is not mandatory. In particular, the location where the actual encoding and compilation is done is not of particular concern in the wireless application environment. It is conceivable that some origin servers will have built-in WML encoders and WMLScript compilers. It may also be possible, in certain cases, to statically store (or cache) particular services in tokenized WML and WMLScript byte code formats eliminating the need to perform any on-the-fly conversion of the deck.

Origin servers provide application services to the end user. The service interaction between the end user and the origin server is packaged as WML decks and scripts. Services may rely on decks and scripts that are statically stored on the origin server, or they may rely on content produced dynamically by an application on the origin servers.

Referring to FIG. 6, there is shown a simplified block diagram representing a basic component interaction model between a web server, a WAP gateway and a WAP client. A user agent initiates a request for a service from an origin server. The WAP browser connects to the WAP gateway with WSP and sends a GET request with that URL. The WAP gateway resolves the host address specified by the URL and creates an HTTP session to that host. The WAP gateway performs a request for the content specified by the URL. The HTTP server at the contacted host processes the request and sends a reply (e.g., the requested content). Encoded content is then sent to the client to be displayed and interpreted. Some optimization may be done at the WAP gateway based on any negotiated features with the client.

It should be understood that various commercial products that address WAP channels are offered by different commercial vendors, with each product implementing its own design and functionality. Some of the commercial products that are designed to handle voice channels include, for example, Nokia Artuse WAP Gateway and Phone.com UP.Link. Based on the disclosure provided herein, a person of ordinary skill in the art should be able to select and/or customize WAP channel products that are commercially available for integration and use as part of the system 10 in accordance with the present invention.

In an exemplary embodiment, the multi-channel gateways utilize XSL transformation for web, voice and WAP channels. One of the challenges in building an application that supports multiple channels is to minimize duplicate presentation and business logic in the channels. In that regard, architecture based on XML and XSL is appropriate for presenting the information to the receiving device and to any number of targets. FIG. 3 is a simplified block diagram illustrating the XML/XSL architecture. In this approach, the content is stored using XML to capture the semantics and structure. Static pages, such as menus, may be stored in their native format (HTML, HDML, WML). When a request for dynamic content is made, the content is extracted from an XML repository and passed through an XSL processor. The XSL processor marries the content and an XSL transformation for the desired target markup language (retrieved from an XSL repository), and generates the desired output. As content is stored once and in one format, transformations are defined once for each content type/output format combination.

1.3.4 E-Mail Channel

An e-mail system includes a mail server and a client. An e-mail client sends outgoing mail to an SMTP server that transfers the mail to other SMTP servers and eventually one of them stores it on the machine from which the client will read it using POP3/IMAP4 protocol.

Many mail servers provide support for message encryption and LDAP support to access operating system directory information about mail users. Currently different industry protocols are available for the e-mail service. Some of the more common protocols for e-mail service include, for example, SMTP, MIME, IMAP4, and POP3. The following is brief descriptions of these commonly used mail protocols.

SMTP (Simple Mail Transfer Protocol) sends non-encoded or MIME-encoded messages. MIME (Multipurpose Internet Mail Extension) can be used to prepare and send messages in formats other than text, to encode messages, and to include attachments. MIME builds and encodes messages with attachments for sending with SMTP, and parses and decodes received messages. The encoded MIME message is passed to SMTP.

Referring to FIG. 7, there is shown a simplified block diagram illustrating how an e-mail is sent through a mail server using SMTP protocol. A SMTP client requests a connection with the SMTP server. The SMTP server responds by acknowledging the connection with a greeting. The SMTP client responds, and, in subsequent commands, specifies the message sender and recipients and sends the message. The SMTP server asks the message transfer agent (MTA) to send the message. In response, the MTA sends the message through SMTP channel.

IMAP4 (Internet Message Access Protocol, version 4) is used to retrieve and manage messages remotely. The user can save messages on the server or locally. In addition, the user can manipulate items on the server (for example, create or delete mailboxes). IMAP4 supports multi-user mailboxes.

POP3 (Post Office Protocol, version 3) is used to connect to a server and retrieve messages. POP3 is simpler than IMAP4 and provides a subset of its capabilities. This protocol supports one user per mailbox.

Referring to FIG. 8, there is shown a simplified block diagram illustrating how an e-mail is received by a mail server and then by a mail client using POP3 or IMAP4 protocol. DNS routes the incoming e-mail to the proxy server in round-robin fashion. DNS can return multiple IPs based on the number of available proxies. The proxy server looks up the mail recipient in the LDAP directory in order to decide which mail server should receive the message. The proxy server then sends the message to the mail server which holds the recipient mailbox. The client connects with the mail server using POP3 or IMAP4 protocol to retrieve the message. This client can be a simple standalone E-mail application, or it can be a part of some other application, which retrieves and processes e-mails. The mail server then sends the requested message/messages to the client.

It should be understood that various commercial products that address e-mail systems are offered by different commercial vendors, with each product implementing its own design and functionality. Some of the commercial products that are designed to handle e-mail include, for example, Eudora World Mail server, iMail server by IPSwitch, iPlanet Messaging server 5.0 and Microsoft Exchange Server. A person of ordinary skill in the art should be familiar with the various technologies that are related to e-mail systems. Based on the disclosure provided herein, a person of ordinary skill in the art should be able to select and/or customize e-mail products that are commercially available for integration and use as part of the system 10 in accordance with the present invention.

1.3.5 FTP Channel

FTP (File Transfer Protocol) is a protocol used to transfer files over a TCP/IP network. A typical example is transferring HTML files to a web server. FTP includes functions to log onto the network, list directories and copy files. FTP also allows conversion between the ASCII and EBCDIC character codes. FTP is designed to handle binary files directly and does not add overhead of encoding and decoding. FTP operations can be performed using browsers, though dedicated FTP utilities are used for additional features such as faster transfer. In general, FTP is divided into a number of categories.

Secure FTP allows files to be downloaded by a secure connection. Some UserID/Password is usually required for uploading and downloading data.

Anonymous FTP allows files to be downloaded by anyone. The anonymous FTP directory is isolated from the rest of the system and will generally not accept uploads from users.

TFTP (Trivial File Transfer Protocol) is a version of the TCP/IP FTP protocol that has no directory or password capability.

It should be understood that various commercial products that utilize FTP are offered by different commercial vendors, with each product implementing its own design and functionality. These products include both server and client software. Some of these commercial products include, for example, Apache web server, Internet Information System (IIS), and iPlanet web server (iWS). There are third party software available as well, e.g., for windows platform, 3D-FTP from SiteDesigner Technology, cuteFTP from GlobalScape, WS_FTP from Ipswitch, etc. WU-FTPD is one of the most popular ftpd developed at Washington University and has SSL patches available to make it secure and reliable. A person of ordinary skill in the art should be familiar with the various technologies that implement FTP. Based on the disclosure provided herein, a person of ordinary skill in the art should be able to select and/or customize products having FTP functionality that are commercially available for integration and use as part of the system 10 in accordance with the present invention.

1.3.6 Fax Channel

The purpose of a fax gateway is to manage the receipt and delivery of faxes. The fax gateway is a bridge between the outgoing and incoming fax messages. A well-designed fax gateway offers extra conveniences for handling incoming faxes, such as direct-to-printer output. The fax gateway may also provide outgoing specialties, such as scheduled broadcasts of a document to many recipients, and automated outgoing faxes triggered by incoming requests.

It should be understood that there is no generic architecture for a fax gateway. Various commercial products that function as fax gateways are offered by different commercial vendors, with each product implementing its own design and functionality. Some of these commercial products include, for example, FAXmaker, SuperFax, and VSI-FAX. A person of ordinary skill in the art should be familiar with the various technologies that are related to fax gateways. Based on the disclosure provided herein, a person of ordinary skill in the art should be able to select and/or customize fax gateway products that are commercially available for integration and use as part of the system 10 in accordance with the present invention.

1.3.7 Voice Response Unit Channel

It should be understood that various commercial products that utilize voice response unit channels are offered by different commercial vendors, with each product implementing its own design and functionality. A person of ordinary skill in the art should be familiar with the various technologies that are related to voice response unit channels. Based on the disclosure provided herein, a person of ordinary skill in the art should be able to select and/or customize products utilizing voice response unit channels that are commercially available for integration and use as part of the system 10 in accordance with the present invention.

1.3.8 Short Message Service Channel

It should be understood that various commercial products that utilize short message service channels are offered by different commercial vendors, with each product implementing its own design and functionality. A person of ordinary skill in the art should be familiar with the various technologies that are related to short message service channels. Based on the disclosure provided herein, a person of ordinary skill in the art should be able to select and/or customize products utilizing short message service channels that are commercially available for integration and use as part of the system 10 in accordance with the present invention.

2. Application Components

The application components subsystem 14 spans a wide range of potential applications and application-related services, used by both programs running in the system 10 and directly by users through the presentation framework 12. The application components subsystem 14 can be extended to provide other types of services as new technologies and products emerge and are incorporated into the system 10 as additional application components, when and where appropriate. In one exemplary embodiment, the application components subsystem 14 provides a number of services including, for example, collaboration, imaging, reporting, search, registration, eCommerce, workflow and subscription management, each of which will be further described below.

2.1 Collaboration

The need for collaboration among internal users of the system 10 and between internal users and external users of the system's applications and services is expected to grow substantially as the transaction volume increases. At its most basic level, collaboration is accomplished using tools such as e-mail, chat, and newsgroups; and more complicated collaboration is carried out using facilities such as shared workspaces and collaborative content development.

In addition to the bi-directional, user-oriented collaboration mechanisms mentioned above, there is also the opportunity for organizational collaboration, in the form of distributed business processes and business-to-business data exchange. Sometimes, this collaboration is one-way: one partner transfers a file to another partner, resulting in some number of transactions at the destination. In other cases, the collaboration can take place in both directions, and multiple interactions may be required in order to complete a single business operation. It is also possible that a party, like a credit card association such as Visa, can use its extensive infrastructure investment and status as a trusted business partner to function as an intermediary between member banks, merchants or even card holders.

The term “collaboration” in the context of Internet technologies and eBusiness applications refers to many different types of interactions, whether interpersonal, intra-organizational, inter-organizational, consumer-focused, or conference-oriented (such as shareholder meeting or press announcements). Such interactions can occur between two individuals, or as one-to-many or many-to-many group interactions, or as human-to-process interactions, or as pure process-to-process interactions (as is the case with “business collaborations”). Various types of collaboration supported by the system 10 including, for example, meeting-oriented collaboration, e-mail messaging and calendaring, instant messaging, community-oriented collaboration and customer-service-oriented collaboration, each of which is further described below.

Meeting-Oriented Collaboration (“Meeting-Ware”)

Meeting-oriented collaboration systems are designed to enable on-demand or scheduled online meetings among any number of individuals. Meetings can be entirely online, used to provide multi-media support for a telephone conference, or used for distributed presentation of a live conference. Meeting-oriented collaborations are usually session-oriented, meaning that the information and record of interaction do not typically persist beyond the life of a meeting. Some of the characteristics of meeting oriented collaboration include:

participant invitation, authentication, and authorization services

meeting scheduling and calendaring

voice chat

text chat

whiteboarding

document sharing

document collaboration (that is, the ability for multiple individuals to see and edit the same document concurrently)

E-Mail Messaging and Calendaring

E-mail messaging and calendaring systems are the traditional e-mail systems used by corporations. Such systems include, for example, Microsoft Exchange, Lotus Notes, POP3 mail, etc. These systems are designed to ensure delivery of a message, text-based or otherwise, to another recipient(s) without the expectation of immediate response or interaction. In general, these messages are created, transmitted, stored, read, and then replied to. The multiple steps taken, and the resultant delay in response, is what differentiates e-mail messaging from another type of messaging, “instant messaging.”

Instant Messaging

Instant messaging was popularized by consumer-oriented technologies such as America OnLine, ICQ, and Yahoo!. Instant messaging is more closely related to chat than to e-ail. Instant messaging systems monitor the computer usage and status of registered users to determine who is available for chat. To initiate a chat with an individual or group, an initial message is sent, and the other individual(s) may immediately reply, typically in short conversational sentences or fragments. Unlike e-mail, the communication has no merit without a two-way interaction, or conversation. Messages are not stored, or persisted on any server for later review or reply. Commercial vendors have developed corporate instant messaging systems that can be centrally managed and integrated with corporate directories and full-featured collaboration systems. Some of the characteristics of an instant messaging system include:

online status monitoring, awareness—the instant messaging system has the ability to determine if another individual is online, active, or available; the interface maintains a list of contacts whose status the user wishes to monitor

on-demand, synchronous chat between two individuals, or among multiple individuals

directory integration—the instant messaging system is able to integrate with a corporate directory; this directory is usable to add contacts to the user's list of “friends” to be monitored

firewall/proxy support

ability to proxy or redirect instant messaging messages through a server, allowing increased control of traffic through the firewall and allow reverse proxy of messages to permit messages and shared areas access from individuals who are outside of the firewall

Community Oriented Collaboration

Community-oriented collaboration solutions are shared, web-based work spaces designed to fit the needs of either predefined or on-demand communities, workgroups, or project teams. Once created, usually through a templated or automatic process, these spaces remain in existence either for the life of a project or indefinitely, until the administrator or owner decides to close the space. These collaborative spaces typically offer a variety of functionality, including:

a membership system that determines whether the space is a public or private space, and registers and authenticates users accordingly

a member directory for contacting members of the community

shared document libraries

threaded discussion groups

project management features

newsletter publishing

Some solutions do not need on-demand, full-featured collaborative spaces. Some situations require only threaded discussion group functionality. If this is the case, then it should be determined if there is an existing, full-featured solution installed that can serve the need; or if a specific threaded discussion package should be purchased. As an example of this, Lotus Sametime offers threaded discussion groups as a part of its offering. If Sametime is already installed for another use, then its discussion capabilities may be leveraged in another application. Some of the characteristics of community-oriented collaboration include:

a membership system

Collaborative spaces are able to be restricted to a defined set of members. The membership system allows both an administrator's definition of members and member self-registration. The membership system also properly identifies, authenticates, and authorizes the members of the space.

shared document management

Members of the community are able to upload documents into an organized structure, and assign user and group security.

threaded discussion groups

Community owners are able to define threaded discussion groups for the community and determine whether community members can define their own groups.

directory integration

The system is able to integrate with a corporate directory or registration system to allow ease of administration, simplified community invitation, single sign-on across communities, and integration with a corporate portal or extranet.

secure support for internal and external community members

The system is able to allow community members who are external to an organization to access the community with out opening the system to vulnerabilities.

Customer Service-Oriented Collaboration

Customer service collaboration is most often seen implemented in Business-to-Consumer (B2C) sites where chat functionality puts a buyer in touch with a customer service representative to assist them with their purchasing needs. Additionally, threaded discussion groups are often used in areas such as customer support.

There are many products on the market that address various collaboration requirements. For example, IBM Lotus has an integrated suite of products, QuickPlace and Sametime, that address some of the collaborative areas relevant to the system 10, as described above, including: meeting-oriented, community-oriented, and instant messaging. A person of ordinary skill in the art should be familiar with the various technologies that are related to collaboration. Based on the disclosure provided herein, a person of ordinary skill in the art should be able to select and/or customize collaboration products that are commercially available for integration and use as part of the system 10 in accordance with the present invention.

2.2 Imaging

Given the number and nature of the credit card transactions, imaging is a key technology to support consistent storage and retrieval of transaction-related information, especially when disputes are involved. Imaging technologies facilitate the handling and management of large amounts of paper and other materials, especially where rapid search and semi-permanent storage is required.

The system 10 defines standardized support for image creation, image storage, backup and restore, search (using metadata or, in cooperation with optical character recognition, by content as well), and online display of imaged materials straight to the desktop.

The imaging service is one of the application components 14 and is used to deliver image files on the basis of a document hardcopy, an unprinted fax or an image file attached to e-mail. This service performs the migration of the incoming document into a digital form. Referring to FIG. 8, there is shown is a simplified block diagram representing a basic component interaction model illustrating how an image is captured and stored into a database. An image is first captured from a hardcopy, a facsimile or from an e-mail attachment. If an image is rejected, a message is sent to the source reporting that the image has been rejected. Form recognition and OCR are applied to the verified images in order to generate an index. Image files are then converted and transferred into database.

In one exemplary embodiment, the imaging service has the following characteristics:

reliable feeding and transport of hardcopies

by high volume, batch scanning for higher performance and less resources allocation

volume requirements (number of pages/images per day) depends on the application

scanning resolution: Generally 300 dpi to match requirements and storage capabilities

image type: 8-bit grayscale (256 possible shades of gray)

indexing: Ability to generate an unique, meaningful ID for each incoming document

customizable image processing to improve quality and avoid rescanning

G3/G4 facsimile format interface for unprinted faxes

interface for extracting images attached to e-mail messages

output Image file format: TIFF and JPG for raster files and PDF for hybrid files

storage of images and the data generated from image processing into optical storage

It should be noted that the above characteristics are non-exhaustive and that this service may include one or more of these characteristics as well as other additional ones. A person of ordinary skill in the art will understand the various combinations of the characteristics that may be associated with this service.

Referring to FIG. 9, there is shown a simplified block diagram illustrating creation of an image. In order to generate the image files, the imaging service provides several sequential modules like image capturing, image processing, verification and indexing, and conversion. The generated image files would be then stored in an optical storage. There is also an iterative process when the image verification and indexing module determines that a particular document needs to be rescanned or, in case of a fax, resent. A document management system is also often involved in managing the images once they are created.

Image Capture

Capturing an image is only necessary when the incoming document is a hardcopy. Capturing means handling batches, scanning the images and producing a data stream that can be edited by the image processing module. Data generated by the scanner driver is written into the working memory where it can be made available for the image processing module.

Image Processing

There are two input channels for image processing module: the optical information generated by the scanner and unprinted faxes in G3/G4 facsimile format. The goal of the image processing module is to improve the image quality in order to increase the accuracy of form and character recognition.

The output generated by the image processing module is generally TIFF G3/G4. TIFF is used because it has broad support, provides the ability to store multiple pages in a single file, and supports a wide variety of image types and compressions. However, it should be realized that other types of format may be used.

Verification and Indexing

The core module of the imaging service is the verification and indexing module. The incoming images can be in TIFF G3/G4 format, if coming from the imaging processing module, or any other format, if coming in as an e-mail attachment. This module performs a number of operations. Images are classified into different form categories like personal checks, letters, stubs, etc. The form recognition is used to identify a particular form, resulting in specific fields being automatically recognized and specific image cleanup being applied. Data extraction from the image file is also performed using Optical Character Recognition (OCR). Rules for data extraction are specified for each form category. Because scanned images are bitmap images, they cannot be retrieved unless there is a data index associated with them. The index is built using the data extracted by OCR.

Image Conversion

The image conversion module is used for converting the image file into new formats that are then stored in a database. There are over 100 file formats available. The choice of file format affects file content and data compression which, in turn, affect storage and transfer of the image files. COTS algorithms that convert image file format allow for optimal selection of file format. ImageMagick is one of a number of COTS products that offer these algorithms.

Optical Storage

The data generated by the image conversion module is stored in a database and utilized for a number of different purposes including, for example, authentication of customer. For images like the signature on a check, the database would have an image of the genuine signature of the customer. All the new checks would always be compared with this image or data generated from this image for the authenticity of the check.

There are several commercial products that substantially provide the imaging service as described above. At the present time, only the interface for images incoming as email attachments is not widely supported by commercial products; however, it should be noted that a person of ordinary skill in the art should be able to implement this functionality into the system 10. These commercial products include, for example, the following:

ActionPoint's InputAccel

Software that converts data into the proper formats usable in back-end systems. It delivers XML, image files, and custom transaction formats.

FileNET's Panagon Image Services

A software solution for storing, managing, and retrieving information of all types from many sources. Panagon Image Services provides a high-volume image and object storage server solution. It is a high-volume digital image server for storing, retrieving, and managing transactional content and objects of all types.

Gauss Interprise's SpyImage

A document capturing application that integrates production-level high-performance scanning, image processing, OCR and indexing.

Kofax's AscentCapture

An XML-based software that enables document capturing via the Internet as well as traditional hardcopy and fax imaging. OCR and indexing are integral part of this product.

ReadSoft's Forms 5

Automatically captures data from all types of documents in any format. This includes paper forms, fax forms, Internet forms, and electronic forms. It recognizes and interprets all types of data: handwritten, machine-printed, barcodes, etc.

TMSSequoia's ScanFix/FormFix

Software for image enhancement and data extraction. It supports OCR and advanced indexing.

Vision Shapes's AutoScan 32

A batch scanning and capture control front-end software designed for volume applications and high speed scanners using ISIS or Twain drivers. It features single or multi-page TIFF, image processing, visual quality control, OCR, etc.

A person of ordinary skill in the art should be familiar with the various technologies that are related to the imaging service as described above. Based on the disclosure provided herein, a person of ordinary skill in the art should be able to select and/or customize various imaging service products that are commercially available for integration and use as part of the system 10 in accordance with the present invention.

FIGS. 10 and 11 are simplified block diagrams illustrating two respective scenarios in which the imaging service as described above is integrated with other applications. Referring to FIG. 10, there is shown a simplified block diagram illustrating how images are validated and accepted. A user first selects a typical document to be scanned. With the selection of the document, the scan helper application would be launched. The document is then scanned. The viewed document can be zoomed and rotated. The user specifies the type of document. The user can add comments to the document. Now the scanned document is ready for imaging service. Image processing would enhance the quality of image in order to increase the accuracy of form and character recognition. The enhanced image is ready for verification and indexing. First, images are classified into different form categories like personal checks, letters, stubs, etc. The form recognition is used to identify a particular form, resulting in specific fields being automatically recognized and specific image cleanup being applied. The index is built using data extractor with OCR. The image file is converted into a new format that is then stored in the database.

Referring to FIG. 11, there is shown a simplified block diagram illustrating a scenario in which a common image conversion utility is provided. A browser requests a web page that has the target image with TIFF format. Through HTTP, the browser asks an application server to retrieve the requested web page. The application server then fetches the requested image of the web page from the database. The TIFF format image is then sent to the imaging service which converts the TIFF format image into a JPG format and sends it back to the application server. The application server then sends the JPG converted image to the browser through HTTP protocol. Now the JPG converted image is ready to be displayed on the browser.

2.3 Reporting

The reporting service supports the consolidation, analysis and review of large quantities of business data. The reporting service interacts with the components of the data management subsystem 20, as further described below. In one exemplary embodiment, the reporting service is provided by supplying a number of centralized reporting servers running software which enables pre-defined or ad-hoc reports to be run in real time or on a scheduled basis. These servers also perform authorization of users to both the reporting tools themselves and to the data upon which reports can be run. Output generated by the reporting services can be accessed and viewed via the system 10 through an HTTP connection.

The reporting service provides report design, generation and delivery capability to other services and applications. In one exemplary embodiment, the reporting service has the following characteristics:

web interface component to deliver reports to users via corporate networks and the Internet

a repository for report storage and retrieval

ability to design, generate and distribute reports

ability to define access privileges on generated reports

“queryable” reports that allow a user to manipulate the data by drilling down, sorting, summarizing fields, or by moving them to another application

ability to integrate with enterprise wide user management infrastructure e.g. LDAP

ability to integrate data drawn from disparate systems and data sources

ability to convert the report data into different formats such as Excel, Word, HTML etc.

multiple operating systems support

API access layer to generated reports

It should be noted that the above characteristics are non-exhaustive and that this service may include one or more of these characteristics as well as other additional ones. A person of ordinary skill in the art will understand the various combinations of the characteristics that may be associated with this service.

Referring to FIG. 12, there is shown a simplified block diagram illustrating an exemplary reporting system. The reporting system includes a report server, a report repository, a report designer, a policy server and output services. The report server performs tasks such as generating, viewing, distributing reports and interacts with other components such as user access privileges and request queues that are part of the report repository. The report repository stores the generated reports, user groups and other relevant information etc. The report designer is a user interface that is used to create reports. Output services include the ability to output the report results in multiple formats such as CSV, MS Word, PDF, etc. The policy server provides a mechanism to control access to the report repository according to some authorization criteria, such as, user names and passwords.

There are several commercial products that substantially provide the reporting service as described above. These commercial products include, for example, Actuate eReporting, Crystal Report, Oracle Reports and Platinum InfoReport. A person of ordinary skill in the art should be familiar with the various technologies that are related to the reporting service as described above. Based on the disclosure provided herein, a person of ordinary skill in the art should be able to select and/or customize various reporting service products that are commercially available for integration and use as part of the system 10 in accordance with the present invention.

2.4 Search

Internet users have come to consider search to be an integral part of any web-based application. The search service provided by the system 10 allows both metadata-based search and, for certain resources, full text search as well. The use of a consistent extensive metadata tag set across all resources helps ensure that users can find the information they want using criteria that are appropriate for the resources being searched. In addition to the search capabilities, this search service provides the facilities to index content and assign metadata. As searchable content or documents are created, they are assigned keywords by the originator; these keywords are then stored as metadata for use in search operations. If full text search is desired, the information is submitted to an indexing engine; the index is stored in a central location for use by all full-text search operations. Restrictions on search capabilities and content to be searched can be imposed based on the originator of the content or document, the roles and permissions of the person issuing the search request, and other security and resource usage policies.

The search service provides a common mechanism for search functionality. The search service focuses primarily on performing searches on relational databases and document stores, but may also include searching against other backend resources. Search service is normally embodied in a search engine component, but may also take the form of outsourced services provided by Internet-based metacrawlers.

The search service provides context search capability to applications within the system 10. Since the search can be performed on database records and documents, the search service is able to support different content data sources including RDBMS, content and document management system, and file system. In one exemplary embodiment, the search service has the following characteristics:

web interface—ability to deliver search results to users via corporate networks and the Internet to their web browsers

scalability—support large and ever-expanding information sources

reliability/availability—with no single point of hardware or data failure

performance—possible performance tuning whenever required

validation—validating and processing information

search/indexing—for structuring and facilitating end users' search

site ranking—ability to rank sites as matched for search queries

multiple language support (double-byte)—ability to support searching, indexing, etc. of multi-byte languages

natural language support—ability to use natural language when performing search operations

secure—if a site has a private, password-protected section, it should not be able to be indexed

It should be noted that the above characteristics are non-exhaustive and that this service may include one or more of these characteristics as well as other additional ones. A person of ordinary skill in the art will understand the various combinations of the characteristics that may be associated with this service.

There are two ways to implement the search service. In one exemplary embodiment, the search service is implemented as a hosted service, where a company hosting the service handles issues regarding scalability, high availability, performance, etc. Google is an example of a search service that is implemented as an externally hosted service. In another exemplary embodiment, the search service is implemented using a product, such as, the Alta Vista Search Engine 3.0.

A person of ordinary skill in the art should be familiar with the various technologies that are related to the search service as described above. Based on the disclosure provided herein, a person of ordinary skill in the art should be able to select and/or customize various search service products that are commercially available for integration and use as part of the system 10 in accordance with the present invention.

2.5 Registration

In one exemplary embodiment, the registration service is used for various different purposes including providing data for user interface personalization thereby allowing appropriate, relevant content to tailored to a user's individual needs; facilitating the assignment of user roles and permissions; reducing administrative work by allowing users to register or un-register themselves, or providing their own user profile management; enabling delegated administration by allowing personnel at parties subscribing to the system 10 to register users on behalf of their respective organizations; and providing important information to applications for use in transaction tracking, audit trails and access logging.

In one exemplary embodiment, the registration service is implemented using common tools to gather appropriate data for a given user and route that data through one or more workflows that are customized based on organizational unit, geographic location, security level, or other guidelines. Registration data is stored in a directory service where it is accessible to all security services and applications.

Any site that has a requirement to restrict access to content and/or functionality based on personal identity, or provide functionality based upon a user's individual attributes, requires some kind of a registration service. The role of registration is to allow a user to become a member of a particular site, or be added to the user base of a particular application.

The registration service can be managed via either user self-service or via administrator intervention, or a combination of the two. Additionally, the registration service is capable of providing ongoing account maintenance tasks, such as, password maintenance, self-service profile management, registration of additional services, such as, newsletters, and user removal from the site or application as appropriate.

The registration service differs from many of the other services in the system 10 in that this service is often implemented directly with other services defined by the system 10, such as, the directory service and certificate management service. The registration service provides additional capabilities, user interfaces, business logic and integration capabilities specific to particular applications or environments based on these other services. The registration service may also be implemented via other means based on business requirements. Regardless of implementation details, the registration service serves at the logical point of management and control for a specific set of users in a specific application domain. Often, this collection of users is shared by other applications and environments. The registration service can optionally provide integration with and rationalization of user context in these environments.

As discussed herein, the products and technologies that sit behind the other services vary based on the needs and architecture of the specific application. Therefore, the implementation and application specific requirements of the registration service may vary depending on the technologies and requirements of the dependent services.

Some of the exemplary features and/or characteristics of the registration service are further described below. Based upon the business and application domain, these features may be implemented as a back-end administration process, a user-drive self-service application or a combination of the two.

User Name Selection and Recommendation

The registration service is able to assist the user in selecting a unique username to use with the scope of a specific application or environment. The user presents a desired username, and the registration service verifies that the username is not already in use. Administrators are able to determine the format of the username and subsequent format restrictions. These restrictions are often determined and implemented in the underlying directory structure. The registration service is aware of these restrictions and enforce them accordingly.

User Profile Submission

In most applications, there are multiple types of user information including, for example, user credentials (e.g., a username, password, or certificate), identity information (e.g., name, contact information, address, organizational unit), and profile information that is of relevance to the specific application or service. The registration service is able to collect this user information, and update the appropriate repository for subsequent use by the application. The application is permitted to interface with the registration service to access and/or update such information through defined interfaces.

Maintain Referential Integrity Across Profile Repositories

When a user's composite profile is maintained in multiple repositories (i.e. an LDAP directory and an application specific database), the registration service is able to ensure that these repositories are synchronized as appropriate. Depending upon the application domain, this feature may be implemented as “best effort” coordination or may enforce full transactional integrity.

Delegated Administration

The registration service is able to support delegated administration. Levels of functionality may vary based on business needs. The most basic form of delegated administration is the delegation of administrative rights to a user to maintain their own account. More advanced delegation capabilities allow users to be segmented and mapped back into to a hierarchical administration structure.

Workflow and Rules Based Validation

Some applications may require that certain business rules be met before a new user can be added to a site or an application. This may be simple rule adherence, such as, ensuring that the account information that a user entered matches that currently in an account database. Other applications may require that a more extensive workflow be completed before a user is made an active member of a site or application.

Profile Management and Editing

Working in conjunction with the authentication and authorization service, as further described below, a user is able to log in and maintain his profile and/or the profiles of those he is entitled to administer. This entails modifying all profile information regardless of the repository in which it resides. The user is not aware of the distribution of profile information and such information is presented in a logical progression.

Password Management

Working in conjunction with the password policies and restrictions of the underlying directory service and security service, as further described below, the registration service is able to provide the end user or administrator with all of the facilities necessary to maintain his/her password. This includes changing passwords at will, executing password changes based on administrative policy, and either resetting or emailing passwords to users depending on security policy.

Enhanced Security Integration

Where specific applications or environments provide for levels of authentication beyond simple password-based authentication, the registration service is able to facilitate the integration of these facilities into the overall user management process. Management of strong authentication, multi-factor authentication, to the extent it involves persistent information associated with the user, is coordinated as part of the registration service to ease and consolidate administration and integration of these services.

Interoperability

Specific registration technologies, user interfaces and administration frameworks are generally interoperable across the directory and security services within the system 10.

As discussed previously, in one exemplary embodiment, the registration service is implemented on top of multiple technologies and provide different levels of functionality depending on the business and functional requirements of the site or application. The registration service interacts primarily with two types of technologies, namely, authentication systems and directories or databases used for profile management. Some common examples of authentication systems include directory services using LDAP, internal Visa NT domains, custom-developed database driven systems, and certificate management systems. Profile management databases can be supported by a variety of relational database servers or directory servers. While custom developed sites may require that the registration service has direct access to the database, more advanced systems and COTS systems are able to provide an API to create and update profile information. Illustrative interactions between the registration service and other services are further described below.

Directory Service Implementation with LDAP

Internet applications have implemented LDAP, a directory and querying standard, in various ways. Some implementations rely heavily on LDAP and store the entirety of a users profile data in the directory; while others use it only as the basis for user management, security and maintaining users' core identity information. In one exemplary embodiment, the registration service provides the coordination and management necessary between the LDAP service and a Siteminder infrastructure, as further described below.

Internal NT Domain

Some applications, such as intranet or knowledge management applications, may need access to internal user profiles. This information may be stored in the Microsoft NT domain directory and is managed via the NT domain and MS Exchange admin tools. If this information is to be used, or updated by other applications, the registration service is able to manipulate this data. As a best practice for directory management, the modification of shared directories are strictly controlled. If entity level security cannot be assigned, then modifications are restricted to centralized control.

Registration Databases

LDAP directories are becoming a more popular and desired choice for the storage and retrieval of relatively stable profile and authentication data, data that changes infrequently. In some cases, using a directory for user profile data may not be possible, or an application may have a legacy implementation that requires direct database access. In these situations, a registration database may exist. Regardless of the underlying technical implementation, there exists a layer of business logic and interfaces to manipulate this data. If databases are used for authentication and profile management, the application's business logic does not have direct query access to this database. A data access layer implemented via the registration service is used to control the interaction to the data. This also simplifies any future migration to a directory service.

Certificate Services

Certificate services are used to issue user certificates based on certain defined identity rules, manage the renewal and revocation of certificates, and potentially serve as a trust authority. After its creation, the user certificate is stored in an external directory. Typically, certificate services are designed to work natively with LDAP services. The certificate creation process provides a set of interfaces or APIs that are integrated into the registration service thereby allowing a user or administrator to step through the process of creating and storing a certificate. An additional role of certificates in the registration service may be in the areas of user or administrator authentication and non-repudiation of changes.

Heterogeneous Registration Services

For a variety of reasons, implementation of a single authoritative registration service may not be feasible or likely. Similar applications sharing similar architectures may be able to share common services but for this to occur, they must be designed from the start. Hence, in one exemplary embodiment, the registration service is designed to be discreet and not be directly integrated or commingled with the business logic of any application. This feature is abstracted and able to be migrated to a different architecture in the future as requirements and architectural directions change.

2.6 E-Commerce

Participation in a transaction process implies a close linkage of e-commerce services. Anytime a party is involved in a transaction process, there are opportunities to offer e-commerce services. Consequently, e-commerce services are included as part of the system 10. The types of e-commerce services included in the system 10 depend on the needs of the users. In one exemplary embodiment, the e-commerce services are provided based on applications utilized by a credit card association, such as, Visa.

E-commerce usually has three distinct models. While Business-to-Consumer (B2C) is the most recognized form, there are also Business-to-Business (B2B) and Person-to-Person (P2P). With respect to the system 10, the B2C model and B2B model are further described below.

Business-To-Consumer (B2C) Model

In business-to-consumer commerce, the following interactions usually occur within each business transaction:

Customers shop at a merchant's website

Merchant takes an order

Merchant sends messages to its acquiring bank to verify the customer's account

If the acquiring bank did not issue the card, then the acquiring bank will send a message to the card's issuing bank

The issuing bank will then verify the account and send either an Accept or a Reject response, which is then relayed all the way back to the merchant

Business-To-Business (B2B) Model

Business-to-business (B2B) is the exchange of products, services, or information between businesses rather than between businesses and consumers. Within the context of the system 10, the e-commerce service offered by the system 10 enables B2B applications to perform the negotiation of orders and payment instruments between business partners. Just as in the B2C model, the e-commerce service offered by the system 10 includes all components and services that support c-commerce applications. Some of the common features are product catalog, shopping cart, and order tracking.

In one exemplary embodiment, the e-commerce service offered by the system 10 provide the following functionality:

Product Catalog—ability to allow easy access to product catalog including searching

Order Tracking—ability to lets customer track orders

Shopping Cart—ability to maintain a shopping cart

Order fulfillment—ability to work with inventory, and shipping systems to fulfill orders

Integration with back-end legacy system—ability to work with a merchant's existing systems

User Registration—ability to manage user information

Scalability—ability to provide the possibility to expansion as needed

Reliability—ability to take and fulfill orders to a customer's satisfaction consistently

Security—ability to offer secure non-repudiable financial transactions through the Internet

It should be noted that no industry standard architecture currently exists for flow or message types for e-commerce servers. Various c-commerce products by different vendors, with each vendor possibly having its unique implementation. Some of the e-commerce products currently on the market include, for example, ATG Dynamo Commerce Server, BEA WebLogic Commerce Server, Blue Martini Commerce Server and IBM WebSphere Commerce Suite. A person of ordinary skill in the art should be familiar with the various technologies that are related to the c-commerce service as described above. Based on the disclosure provided herein, a person of ordinary skill in the art should be able to select and/or customize various e-commerce products that are commercially available for integration and use as part of the system 10 in accordance with the present invention.

2.7 Workflow

Workflow is the routing of data through a series of steps in a business process that results in a finished task. A given business process workflow can be as simple or as complex as desired, with capabilities ranging from the simple execution of a sequence of steps to complex routing based on business rules, input data, user profile, and a host of other factors.

Most workflow engines provide the ability for steps in a business process to be performed by a combination of humans and automated agents across any number of geographies and time zones, providing even more flexibility in process execution. Steps can be assigned to an individual, a group of individuals, or to a pool of workers. Assigned tasks appear in a task list owned by the assigned individual or group, and the assigned worker(s) are notified of the task via e-mail or another appropriate mechanism. The task list can be accessed through standard HTTP facilities, allowing the assigned individual or group to work on the task from anywhere. If a key task owner is unavailable, workflow administrators can reassign the task to another capable individual.

The workflow service is a service which provides automation of business processes, in whole or in part, during which information of any type is passed from one participant to another for actions, according to a set of predefined intelligent business rules that allow computers to perform most of the work while humans only have to deal with exceptions. In one exemplary embodiment, the workflow service offered by the system 10 has the following characteristics:

Process Design and Definition Capability—ability to design and/or model the workflow process and its constituent activities

Process Execution and Management Capability

Process Monitoring Capability—ability to provide performance data that enable organizations to monitor existing processes, identify/isolate problems, and evaluate organizational performance and improve business process flows

Event Management and Application Integration—ability to provide a mechanism to design and execute event driven processes, such as, integration actions sending events including, for example, notification or information to applications, thereby enabling an application to communicate with a workflow engine to accept application data, signal and respond to activity events, etc.

Scalability

Security—ability to support a role-based access control scheme and leverage a common LDAP-based authentication directory

It should be noted that the above characteristics are non-exhaustive and that this service may include one or more of these characteristics as well as other additional ones. A person of ordinary skill in the art will understand the various combinations of the characteristics that may be associated with this service.

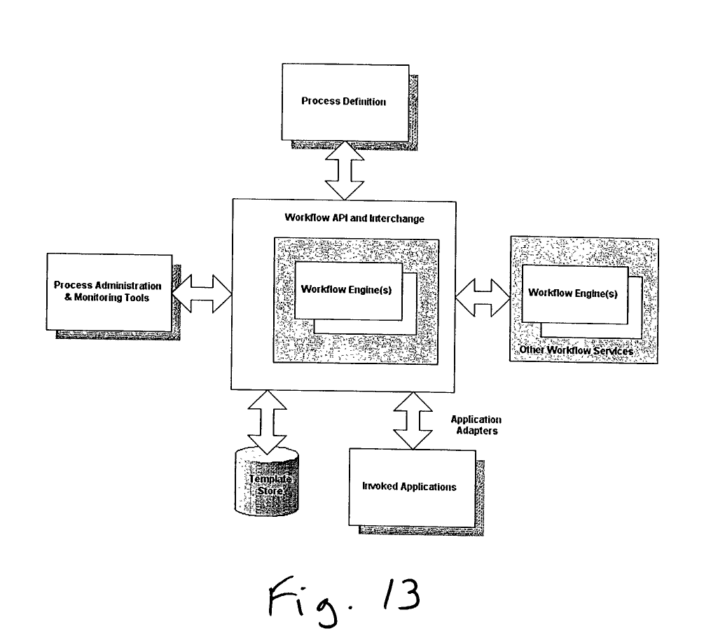

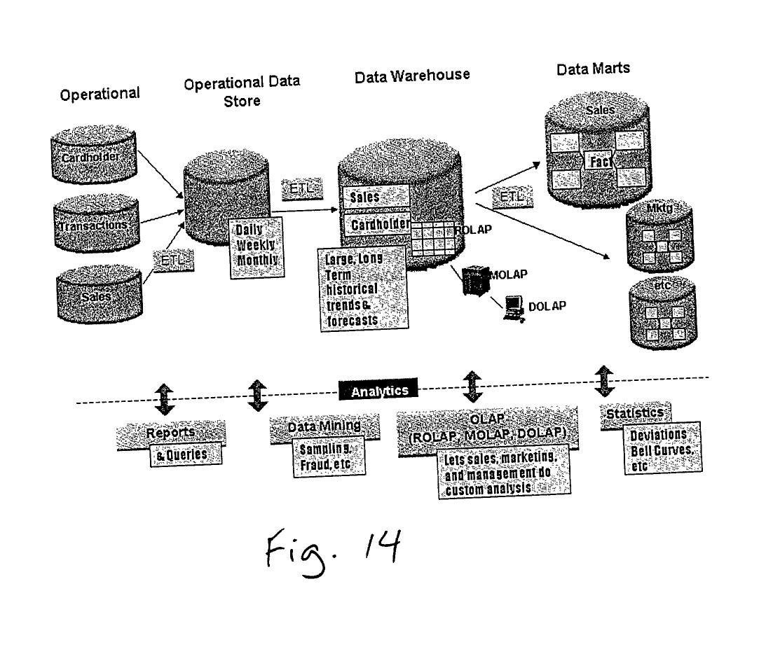

Referring to FIG. 13, there is shown a simplified block diagram illustrating an exemplary workflow service architecture. The workflow process definition component allows a business group to design processes using certain pre-defined elements. This component contains several elements found in an end-to-end business process. Using this component, the designer can identify process start and end points and other discrete process activities. The workflow process & forms template repository allows for process reuse. These defined processes can be retrieved, duplicated and modified at any other point in the business process. The workflow process administration and monitoring component provides data to optimize business processes. The data that may be used to optimize the business processes include, for example, process statistics (i.e., information such as process execution time metrics, task status etc.), process workload (i.e., data regarding workflow process distribution, number of instances etc.) and process work lists monitoring (i.e., data representing a view of tasks assigned to a certain user or group and administrative capability to change those assignments to make the flow more efficient). The workflow application adapters enable external application integration, which generally follow industry standards.

Interface with other components of the system 10 is provided via a combination of Java classes and XML. In order to integrate with a workflow engine, the following interfaces are used:

Workflow Application API—to enable client application to directly work with the workflow engine, e.g. invoking workflow instance, passing application specific data, event etc.

Workflow Process Definition API—to provide the capabilities to create, interchange and modify the process definition template.

Workflow Application Adapters—to enable the integration of workflow engine and the external application(s). Business operations performed by the external application can be invoked from the workflow engine and have the results returned back to the workflow engine if required.

Application Organization API—to enable the workflow engine to access application specific organization data for workflow process modeling.

Some of the e-commerce products currently on the market include, for example, BEA Process Integrator and Fujitsu iFlow. A person of ordinary skill in the art should be familiar with the various technologies that are related to the workflow service as described above. Based on the disclosure provided herein, a person of ordinary skill in the art should be able to select and/or customize various workflow service products that are commercially available for integration and use as part of the system 10 in accordance with the present invention.

2.8 Subscription Management

The system 10 also provides subscription management as part of its application components 14. It is often appropriate for users to be able to subscribe to notifications of new content or to changes in existing content. This content can take many forms, ranging from simple HTML page fragments to complex business documents; even the output of applications and services can be subscribed to complementing the organization's collaboration capabilities by keeping members abreast of new developments. Subscription to content and services can be done through a service that leverages information already gathered by the registration service as described below. Users can view a list of available subscriptions that is tailored to their security profile, and may subscribe or unsubscribe themselves, be enrolled by others or have subscriptions created automatically.

In one exemplary embodiment, the subscription management service offered by the system 10 provides a list management service based upon sending categorized e-mail to a managed distribution list. Some of the characteristics of the subscription management service offered by the system 10 include:

Management of lists of e-mail addresses—typically e-mail addresses are in the Internet standard format and lists are managed with a single level, or perhaps one level deep hierarchy of simple text names; user names may be optionally associated with additional personal information and attributes such as name, phone number, etc.

Self registration and auto-responder—e-mail is used as a primary self-management mechanism, using subscribe-listname@listhost style e-mail addresses to subscribe and unsubscribe-listname@listhost email addresses to unsubscribe; requests to these email addresses are parsed on the list server and the senders e-mail address extracted; and auto-response confirmation to the sender is often implemented.

Web-based registration—a complement to the e-mail response, a web page providing the same subscribe/unsubscribe functionality.

Confirmation of registration—for added security and list integrity, some auto-responders issue a confirmation message that must be either responded to from the email address requesting action or containing a URL to access to confirm the action, thereby helping to prevent anonymous or unauthorized subscriptions.

Templates for sending email—provide simple e-mail or web-based templates for composing messages to be sent.

Message sender security and workflow—restrict sending of messages to a small set of users, or provide simple workflow for messages to be approved before they are sent.

Automated bad address handling—provide an automatic facility for handling messages routed to bad email addresses, bounced messages and potentially resending to full mailboxes; this feature may be implemented in a selected product or integrated into the implementation of the subscription management service.

Mail merge functionality—provide a simple mail merge facility for combining the user names and attributes with the outbound messages and support simple text replacement; optionally, modification of MS Office documents or PDF files may be allowed.

It should be noted that the above characteristics are non-exhaustive and that this service may include one or more of these characteristics as well as other additional ones. A person of ordinary skill in the art will understand the various combinations of the characteristics that may be associated with this service.

Currently, there are several products in the market that focus exclusively on subscription management. These products include, for example, L-Soft's LISTSERV, Lyris ListManager and the open source majordomo. A person of ordinary skill in the art should be familiar with the various technologies that are related to the subscription management service as described above. Based on the disclosure provided herein, a person of ordinary skill in the art should be able to select and/or customize various subscription management service products that are commercially available for integration and use as part of the system 10 in accordance with the present invention.

3. Application Servers

By providing the key underpinnings of application development, the application servers 16 form the core of the system 10 from the application's perspective. The application servers 16 include one or more servers that are configured to perform different functions including, for example, application runtime, personalization, authentication, authorization and single sign-on, directory and naming management and certificate management, each of which are further described below.

3.1 Application Runtime

The application runtime component provides a common execution environment and related services for applications developed within the system 10. The application runtime component covers three aspects of application development:

application runtime environments to be used by the various programming languages supported by the system 10

complementary tool sets (graphics and windowing libraries, XML utilities, and so on)

specifications to be used when certifying other system components for use with the application runtime component and/or when certifying new programming languages for use with existing system components

For Java and Java 2 Enterprise Edition (J2EE) applications, implementation of the application runtime component defines the supported Java Runtime Environments (JREs), J2EE application servers and complementary tool libraries across a suite of applications developed within the system 10.

For Microsoft .Net applications, the application runtime environment includes certified Microsoft product releases and complementary tool libraries on each of the system platforms.

The certification of application runtime environments is important. Application runtime environments such as those for Java change on a regular basis. Such environments cannot be introduced into the system environment without first certifying that they can be used successfully with the other key system components. A new JRE or C++ runtime, for example, is certified for use with components such as:

system security facilities, including digital certificate tools, encryption, and directory services interfaces

enterprise application integration (EAI) tools, and in particular the language-specific stubs used to access messaging and data transformation services

application programming interfaces (APIs) for vendor products such as content management, workflow and eCommerce services;

cross-language communication, including that provided by the Java Native Interface (JNI) facility

Certification of new runtime environments provides the application developer with a level of confidence that they may use the new environment without encountering cross-product or cross-language compatibility issues.

The application runtime is the service within which most system applications are executed, the service is responsible for serving as the container that runs applications and manages startup, shutdown and other process and thread lifecycle services. In one exemplary embodiment, the application runtime component is implemented with commercial application server technology. Some of the more popular application servers include, for example, BEA WebLogic, IBM WebSphere, iPlanet Application Runtime, and IIS/ASP/.Net from Microsoft.

These application runtime environments provide the framework for building web-based applications. They handle core functions required by applications including presentation services (interacting with the user), business logic services (allocating and cleaning up business objects in memory), and system interfaces (interacting with databases, message queues, and other systems).

In one exemplary embodiment, the application runtime component has the following characteristics:

Presentation and access runtime support

support dynamic web page creation including support for the most basic interaction with web-based clients including creating dynamic web pages and support for servlets, JSP—Java server pages, ASPs—application server pages

support session management, or the ability to maintain state in a scalable, fault-tolerant, and high performance manner between the user that interacts with web pages and the web application

Application business runtime support

support business object containers that are responsible for managing the memory of the business objects including support for EJBs—Entity Beans, Session Beans, Java beans, and Microsoft COM+ objects

allocating, cleaning up, and pooling memory used by these business objects

caching objects and instantiating distributed objects through location transparency

Application integration runtime support

support database access including database connection pooling, JDBC, and ADO connections and commands

support integration with other connection protocols including CORBA/IIOP and J2CA-J2EE Connection Architecture (Mainframe and Disparate System Integration)

Support message and transaction based integrations including MTA (Microsoft Transaction Architecture), JMS (Java Messaging Service), JTA (Java Transaction API) and JTS (Java Transaction Service)

support web services including support for SOAP, WSDL, and UDDI

It should be noted that the above characteristics are non-exhaustive and that the application runtime may include one or more of these characteristics as well as other additional ones. A person of ordinary skill in the art will understand the various combinations of the characteristics that may be associated with the application runtime.

As mentioned above, the application servers 16 provide the application runtime service. This service is available from a number of products including, for example, BEA WebLogic, IBM WebSphere, and Microsoft .Net, iPlanet Application Server, ATG Dynamo, Tomcat, and Cold Fusion. A person of ordinary skill in the art should be familiar with the various technologies that are related to the application runtime service as described above. Based on the disclosure provided herein, a person of ordinary skill in the art should be able to select and/or customize various application server products that are commercially available for integration and use as part of the system 10 in accordance with the present invention.

3.2 Personalization

The personalization service provides system applications with the ability to tailor their interactions with end users such that a user perceives the maximum value from the application interaction. In many cases, personalization is accomplished through a combination of user interaction tracking (clickstream analysis, for example), preferences expressed by the user (through registration, for example) and directives imbedded in applications that leverage this information to tailor their output to the particular user being served.

Note that there is an important distinction between personalization and customization which is the ability for a given user to tailor the layout, color scheme, fonts and other visual aspects of the user interface through which a user accesses the system services. Portals extend the users' customization capabilities by, for example, allowing them to select the information (that is, the various portal “widgets”) that is visible when they start the portal interface. Customization capabilities are interface-specific, and are provided by the presentation framework 12.

The personalization service supports rule-based and/or scenario-based targeting for system services and applications. This is usually a feature provided by most application servers. There is no standard in personalization. However, most COTS products have a similar architecture that contains the following components including user profile management, rules management and content management.

In one exemplary embodiment, the personalization service offered by the system 10 has the following characteristics:

profile management—ability to store, modify and query user profiles, a user profile including a list of properties that describe a user's characteristics

content management—ability to manage and store content in searchable repositories (databases, file systems or third party content management systems), content being units of information available to display to web site users

content targeting with business rules—the process of displaying content items to a particular user, at a particular time, in a particular context, depending on the business rules

It should be noted that the above characteristics are non-exhaustive and that this service may include one or more of these characteristics as well as other additional ones. A person of ordinary skill in the art will understand the various combinations of the characteristics that may be associated with this service.

Various products are available which offer personalization services, with product vendors creating their own respective designs and implementations. Some of the products that are currently available on the market include, for example, ATG's Dynamo Personalization Server, BEA WebLogic Personalization Server, and IBM WebSphere Server. A person of ordinary skill in the art should be familiar with the various technologies that are related to personalization services as described above. Based on the disclosure provided herein, a person of ordinary skill in the art should be able to select and/or customize various currently available products that offer personalization services for integration and use as part of the system 10 in accordance with the present invention.

3.3 Authentication, Authorization and Single Sign-On

The authentication, authorization and single sign-on service or component provides the facilities for verifying the identity of a given entity, determining what system applications and services within the system 10 a given entity is entitled to access, and coordinating authentication and authorization across application systems that are built based on the system 10. This component uses the directory component, to be further described below, to store all of the information required to perform these tasks.

The authentication capabilities of this component are flexible and are both based on specific application needs and insulated from those applications. Applications with low or moderate security needs can rely on userid-password or digital certificate authentication, while higher-security applications can use smart cards, biometrics or some other authentication mechanisms. The exact facilities used to respectively satisfy the security needs of the applications are transparent to the applications themselves.

The roles- and permission-based authorization structure provides maximum flexibility to applications. Using this information, the single sign-on tool can deny application access completely or provide access to only selected portions of the application. The roles and permissions allocated to a given user can also be passed to the application for finer-grained control over data access (allowing access to data from only one region, for example) and/or the ability to perform certain application-specific operations (such as data updates).

The authentication, authorization, and single sign-on service provides accurate user identification and user access control to applications within the system 10. In one exemplary embodiment, the authentication, authorization, and single sign-on service as provided by the system 10 has the following characteristics:

single sign-on on authentication and authorization services for all web applications within the system 10

centralized security management enables developers to deliver secure, personalized web applications by managing the complex security requirements for different web applications

scalability to support large and ever-expanding user/policy database

reliability with no single point of hardware or data failure

security to prevent unauthenticated user or unauthorized request from getting access to the protected resources

It should be noted that the above characteristics are non-exhaustive and that this service may include one or more of these characteristics as well as other additional ones. A person of ordinary skill in the art will understand the various combinations of the characteristics that may be associated with this service.

Various products are available which offer authentication, authorization, and single sign-on service, with product vendors creating their own respective designs and implementations. Some of the products that are currently available on the market include, for example, Arcot WebFort and Accessfort, Entrust's Entrust/Signon, and Netegrity's SiteMinder. A person of ordinary skill in the art should be familiar with the various technologies that are related to the authentication, authorization, and single sign-on service as described above. Based on the disclosure provided herein, a person of ordinary skill in the art should be able to select and/or customize various currently available products that offer the authentication, authorization, and single sign-on service for integration and use as part of the system 10 in accordance with the present invention.

3.4 Directory

The directory service or component provides a hierarchical mechanism for storing and retrieving information about any entity, whether it be a user of the system applications and services, the applications and services themselves, or components of a third party network infrastructure. The directory service is flexible, and attributes can be added, removed or changed in a very straightforward fashion.

In one exemplary embodiment, the directory service is an online system that is built on a hierarchical database optimized for read operations. This hierarchical database contains descriptive attributes for its entries. Entries can reflect a network topology, company organizational data (employee information), etc. A directory is used mainly for doing lookups. Data replication is the key when availability, reliability and performance are considered. In one exemplary embodiment, the directory service as provided by the system 10 has the following characteristics:

enterprise repository for the consolidation of various types hierarchical data for an enterprise

scalability to allow the enterprise repository to expand as needed

reliability to offer reliable data replication utilities

security to enable secure interactions with the data maintained by the directory server

It should be noted that the above characteristics are non-exhaustive and that this service may include one or more of these characteristics as well as other additional ones. A person of ordinary skill in the art will understand the various combinations of the characteristics that may be associated with this service.

Various products are available which offer directory service, with product vendors creating their own respective designs and implementations. Some of the products that are currently available on the market include, for example, iPlanet Directory Server offered by the Sun and AOL/Netscape Alliance. A person of ordinary skill in the art should be familiar with the various technologies that are related to the directory service as described above. Based on the disclosure provided herein, a person of ordinary skill in the art should be able to select and/or customize various currently available products that offer the directory service for integration and use as part of the system 10 in accordance with the present invention.

3.5 Naming

The naming service or component serves as the translation mechanism for names assigned to entities in an organization which in one exemplary embodiment is a credit card association such as Visa. Computers, networked resources, applications and services can all be named. By allowing access only by name, these resources can be physically moved or reconnected with no impact on applications or users that use them.

The naming service provides an interface for performing name-based lookups. Clients of this service employ it to obtain references to remote objects and other resources. Regardless of the underlying naming technology, be it LDAP, CORBA's COS naming service, or DNS, the naming service provides a consistent, simple interface that encapsulates these different mechanisms.

The advantage of using the naming service is that while different services can have vastly different naming schemas, Java applications are able to navigate across databases, files, directories, objects and networks seamlessly.

In one exemplary embodiment, the naming service offered by the system 10 is implemented using the industry standard: Java Naming and Directory Interface (JNDI), which is an application programming interface that provides naming and directory functionality to applications written using the Java programming language. A person of ordinary skill in the art will know how to utilize the JNDI to implement a naming service in accordance with the present invention.

Furthermore, it is common to find a variety of directories—many playing an administrative role—that are deployed within a single organization. These include network resource directories, such as an LDAP-based directory, Active Directory, Netscape Directory Service, Microsoft Windows® operating system Directory Service, and Novell Directory Services, as well as application-specific directories, such as Lotus Notes, cc:Mail, or Microsoft Exchange Server Mail. Microsoft offers an interface for managing multiple directories: the active directory service interfaces (ADSI). ADSI is a set of COM programming interfaces that make it easy for customers and independent software vendors (ISVs) to build applications that register with, access, and manage multiple directory services with a single set of well-defined interfaces.

3.6 Certificate Management

Certificate management takes on the role of managing digital certificates assigned to users, applications and services. These digital certificates can be used to both authenticate users and encrypt data exchanged with these users such that only the intended user can decrypt it.

Certificate management is typically performed using certificate servers. When a certificate is created, it is stored in one or more servers, where it can be retrieved as needed for data encryption. When an employee leaves an organization, the certificate can be revoked by administrators at the server, preventing its future use.

Certificate management is used to issue and manage digital certificates. There are two types of solutions to manage enterprise certificate needs. The first type of solution is to purchase COTS certificate management software and set up certificate management servers. The other option is to purchase certificate management services from a certificate management service provider; for example, Verisign is a popular certificate management service provider.

In one exemplary embodiment, the certificate management offered by the system 10 follow the Network Working Group's RFC 2510 and has the following characteristics:

PKI management conforms to the ISO 9594-8 standard and the associated amendments (certificate extensions).

PKI management conforms to the other parts of this series.

Ability to regularly update any key pair without affecting any other key pair.

Use of confidentiality in PKI management protocols is kept to a minimum in order to ease regulatory problems.

PKI management protocols allow the use of different industry-standard cryptographic algorithms, (specifically including RSA, DSA, MD5, SHA-1)—meaning that any given CA, RA, or end entity may, in principle, use whichever algorithms suit it for its own key pair(s).

PKI management protocols do not preclude the generation of key pairs by the end-entity concerned, by an RA, or by a CA-key generation may also occur elsewhere, but for the purposes of PKI management key generation can be regarded as occurring wherever the key is first present at an end entity, RA, or CA.

PKI management protocols support the publication of certificates by the end-entity concerned, by an RA, or by CA.

PKI management protocols support the production of Certificate Revocation Lists (CRLs) by allowing certified end entities to make requests for the revocation of certificates—this is done in such a way that the denial-of-service attacks which are possible are not made simpler.

PKI management protocols are usable over a variety of “transport” mechanisms, specifically including e-mail, http, TCP/IP and ftp.

Final authority for certification creation rests with the CA; no RA or end-entity equipment can assume that any certificate issued by a CA will contain what was requested—a CA might alter certificate field values or may add, delete or alter extensions according to its operating policy. In other words, all PKI entities (end-entities, RAs, and CAs) are capable of handling responses to requests for certificates in which the actual certificate issued is different from that requested (for example, a CA may shorten the validity period requested). Note that policy may dictate that the CA do not publish or otherwise distribute the certificate until the requesting entity has reviewed and accepted the newly created certificate (typically through use of the PKIConfirm message).

A scheduled changeover from one non-compromised CA key pair to the next, that is, CA key update is supported (note that if the CA key is compromised, re-initialization is performed for all entities in the domain of that CA). An end entity whose PSE contains the new CA public key (following a CA key update) is able to verify certificates verifiable using the old public key. End entities that directly trust the old CA key pair are able to verify certificates signed using the new CA private key. Required for situations where the old CA public key is “hardwired” into the end entity's cryptographic equipment.

The CA itself may in some implementations or environments, carry out the functions of an RA. The protocols are designed so that end entities will use the same protocol regardless of whether the communication is with an RA or CA.

Where an end entity requests a certificate containing a given public key value, the end entity is ready to demonstrate possession of the corresponding private key value.

The certificate management offered by the system 10 also has the following characteristics:

Scalability—provide expansion space to be able to issue and manage increasing number of certificates.

Reliability—certificates have a consistent format and the issuing process is reliable.

Security—certificate and key storage are secure.

It should be noted that the above characteristics are non-exhaustive and that this service may include one or more of these characteristics as well as other additional ones. A person of ordinary skill in the art will understand the various combinations of the characteristics that may be associated with this service.

Various products are available which offer certificate management, with product vendors creating their own respective designs and implementations. Some of the products that are currently available on the market include, for example, the iPlanet Certificate Management System, and the RSA Keon Certificate Server. A person of ordinary skill in the art should be familiar with the various technologies that are related to certificate management as described above. Based on the disclosure provided herein, a person of ordinary skill in the art should be able to select and/or customize various currently available products that offer certificate management for integration and use as part of the system 10 in accordance with the present invention.

3.7 Session Management

Session management provides the ability to maintain state in a scalable, fault-tolerant, and high performance manner. State information includes HTTP sessions, stateful session beans and entity beans. In one exemplary embodiment, the session management offered by the system 10 has the following characteristics:

Session fail over support—when the application server maintaining a users session fails, the session for that user is migrated to another application server; the alternate application server without disruption of service handling the user requests.

Session tracking—passing data generated from one request onward, so it can be associated with data generated from subsequent requests; the application server storing all the data related to the user session so that it can be retrieved at any late time.

Secure session management—the session management maintains information like the user's IP address or sub-net mask in the session, the information being one-way hash encrypted in the session string.

It should be noted that the above characteristics are non-exhaustive and that this service may include one or more of these characteristics as well as other additional ones. A person of ordinary skill in the art will understand the various combinations of the characteristics that may be associated with this service.

Session management is a service provided by application servers. Various products are available which offer session management, with product vendors creating their own respective designs and implementations. Some of the products that are currently available on the market include, for example, ATG Dynamo, BEA WebLogic, and iPlanet. A person of ordinary skill in the art should be familiar with the various technologies that are related to session management as described above. Based on the disclosure provided herein, a person of ordinary skill in the art should be able to select and/or customize various currently available products that offer session management for integration and use as part of the system 10 in accordance with the present invention.

4. Asset Management

The asset management subsystem 18 controls the production and management of content and documents stored on the system 10. There are two different components in this subsystem 18: the content management component, which controls web-based content and delivery channels, and document management, which controls the production of documents.

“Content” is considered to be information created in text, graphical, video, animation, or other forms which is targeted to distribution using web technologies (HTML, graphics, Flash/Shockwave, Real Media, and so on). An item of content is also considered to be smaller in volume than a document, with most being on the order of one to several paragraphs of text; these items may be intended to be displayed by themselves or in conjunction with other content items. Content also generally contains hyperlinked references to other content items, documents, or off-site resources. A single item of content may comprise of different media, such as a text item with embedded graphics. “Documents” are more lengthy items, usually produced in Microsoft Word or Adobe PDF format, which deal with specific topics of interest.

4.1 Content Management

The content management service or component is responsible for providing services that assist with authoring, editorial workflow, change management and access auditing, publication and expiration, and versioning of content. There are several commercial software packages that perform the functions described above and much more (such as the generation of content by external freelance authors, globalization of content, syndication, etc.). Preferably, a content management tool would handle any type of content possible.

Because there is a completely separate aspect of the system 10 that handles the presentation of content to end users (as well as other content presentation functions such as targeting, personalization and syndication), the content management system allows content to be created and stored in a universal format such as XML. These content items are tagged with metadata that allows them to be stored, searched and personalized based on rules stored elsewhere.

The content management component is responsible for storing, tracking, and retrieving digital contents such as images, audio clips, and video clips, and managing the publishing and deployment of these contents to the web.

In one exemplary embodiment, the content management component of the system 10 has the following characteristics:

Support and facilitate large-scale content creation—Large number of Web assets created by a variety of business or/and technical contributors using different desktop or web-based tools

Support static and/or dynamic content management

Easy to integrate with other eBusiness application servers for development and personalization

Facilitate rapid and reliable content distribution and deployment

High scalability and availability

Support role-based access control for content evolution and deployment

It should be noted that the above characteristics are non-exhaustive and that this service may include one or more of these characteristics as well as other additional ones. A person of ordinary skill in the art will understand the various combinations of the characteristics that may be associated with this service.

Various products are available which offer content management, with product vendors creating their own respective designs and implementations. Some of the products that are currently available on the market include, for example, Documentum 4i and Interwoven TeamSite. A person of ordinary skill in the art should be familiar with the various technologies that are related to content management as described above. Based on the disclosure provided herein, a person of ordinary skill in the art should be able to select and/or customize various currently available content management products for integration and use as part of the system 10 in accordance with the present invention.

4.2 Document Management

Just as the content management components handles many common tasks for content items, the document management component is responsible for providing those same services for documents. As with content management, there are several available commercial software packages that provide the required functionality and more. There is some functional overlap between content management and document management tools. Unlike content, documents are generally distributed in a small number of common formats, the most prevalent of which are Microsoft Word and Adobe PDF. This creates some major differences in process between content management and document management:

The tools used to generate documents are substantially different from those used to generate content. This difference affects the repositories used to store the data and the organization of that data in the repositories.

In this context, documents are much more likely than content items to be created by a focused team within a single department (or small number of departments). While the need for editorial review and workflow still exists, the process for doing so varies greatly. Where there are often a large number of relatively small content items which comprise a section of a web site (for example), documents tend to be comprised of a small number of larger sections, with correspondingly fewer (but more intense) editorial review sessions.

While content items are viewed using a browser or (for rich media) a browser plug-in, documents can be viewed using a browser plug-in or a standalone document viewer.

The document management service or component supports different capabilities including document management, workflow, document indexing, and context search. In one exemplary embodiment, the document management service offered by the system 10 has the following characteristics:

A robust and scalable system for all type of content management.

An open architecture for integration with front- and back-end office applications.

Role based security for controlling access to content.

Document indexing and searching capabilities.

Support for workflow and content lifecycle management.

It should be noted that the above characteristics are non-exhaustive and that this service may include one or more of these characteristics as well as other additional ones. A person of ordinary skill in the art will understand the various combinations of the characteristics that may be associated with this service.

Various products are available which offer document management, with product vendors creating their own respective designs and implementations. Some of the products that are currently available on the market include, for example, Documentum 4i and Panagon FileNET. A person of ordinary skill in the art should be familiar with the various technologies that are related to document management as described above. Based on the disclosure provided herein, a person of ordinary skill in the art should be able to select and/or customize various currently available document management products for integration and use as part of the system 10 in accordance with the present invention.

5. Data Management

The data management subsystem 20 provides services that enable the comprehensive and effective use of data assets maintained by a party running the system 10. In an exemplary embodiment, the party running the system 10 is a credit card association such as Visa. By using the system 10, in particular, the data management subsystem 10, users do not typically access Visa's data assets directly. Rather, they are provided access to the appropriate data (based on their roles and permissions) through Visa's applications and services, including both applications created in-house and packaged applications purchased through third-party vendors. The data management subsystem 20 further includes a number of services or components including a data warehouse, statistics and data mining service, ETL and OLAP, each of which is further described below.

5.1 Data Warehouse

The data warehouse is a repository of integrated information, which is extracted from heterogeneous sources and stored in the data warehouse as it is generated. Because the data is pre-extracted and pre-integrated, data queries and analysis are much easier and more efficient.

Data typically passes through a two step process on its way from the various sources to the data warehouse. In most organizations, there is a single large repository called an “operational data store” (ODS) which is used to aggregate and integrate data, and often serves as an up-to-the-minute picture of an organization's operational data. Detailed data is extracted from the applications, transformed and cleansed, and placed into the ODS. Then, data used in decision support and analysis is extracted from the ODS and stored in the data warehouse in an optimized format. In most cases, more focused subsets of the data are extracted from the data warehouse and stored in department- or group-level data stores, called “data marts”. These data marts can be created at any level—from larger regional data marts to departmental data marts—and serve to support more focused reporting, business intelligence and analytical processing.

The data management subsystem 20 supports the creation and maintenance of the ODS, the data warehouse and the data marts by using an underlying relational data store and complementary tools to enable the creation and maintenance of these repositories. Some of the tools used by the data management subsystem 20 include:

Statistical analysis and data mining tools, which allow the identification and analysis of key business indicators

Extraction, transformation and load (ETL) tools, which facilitate the movement and cleansing of data as it makes its way from the applications that generate it to the data warehouse and data marts

On-line Analytical Processing (OLAP) tools which provide for fast analysis of shared multidimensional data

The defining characteristic of the data warehouse is its purpose. The data warehouse collects, organizes, and makes data available for the purpose of analysis—to give management the ability to access and analyze information about its business. The data warehouse is a repository of integrated information, available for queries and analysis. Data and information are extracted from heterogeneous sources as they are generated. This makes it much easier and more efficient to run queries over data that originally came from different sources.

Data marts are closely related to data warehouses. A data mart is a repository of data gathered from operational data and other sources that is designed to serve a particular community. In scope, the data may derive from an enterprise-wide database or data warehouse or it may be more specialized. The emphasis of a data mart is on meeting the specific demands of a particular group of knowledge users in terms of analysis, content, presentation, and ease-of-use.

In practice, the terms data mart and data warehouse each tend to imply the presence of the other in some form. The data warehouse is a central aggregation of data, while the data mart is a repository that may derive from the data warehouse, emphasizing ease of access and usability. The design of a data mart tends to start from an analysis of user needs, but the design of a data warehouse tends to start from an analysis of what data already exists and how it can be collected. In general, a data warehouse tends to be a strategic but somewhat unfinished concept; a data mart tends to be tactical and aimed at meeting an immediate need.

A data mart would be related to, but independent from, the architecture, technology, products, and other properties of the data warehouse from which it received its contents. However, the guiding principles of the data mart are same as the data warehouse subject oriented and non volatile.

In one exemplary embodiment, the data warehouse provided under the data management subsystem has the following characteristics:

Subject-oriented—data that gives information about a particular subject instead of about a company's on-going operations

Integrated—data that is gathered into the data warehouse from a variety of sources is merged into a coherent whole

Time-variant—all data in the data warehouse is identified with a particular time period

Non-volatile—data is stable in the data warehouse, i.e., data is accumulated and never removed

It should be noted that the above characteristics are non-exhaustive and that the data warehouse may include one or more of these characteristics as well as other additional ones. A person of ordinary skill in the art will understand the various combinations of the characteristics that may be associated with the data warehouse.

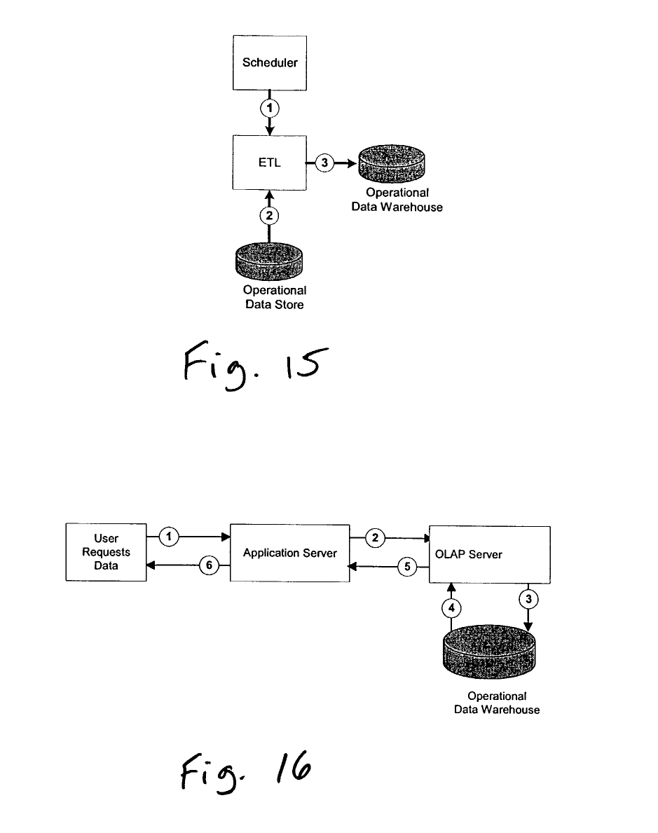

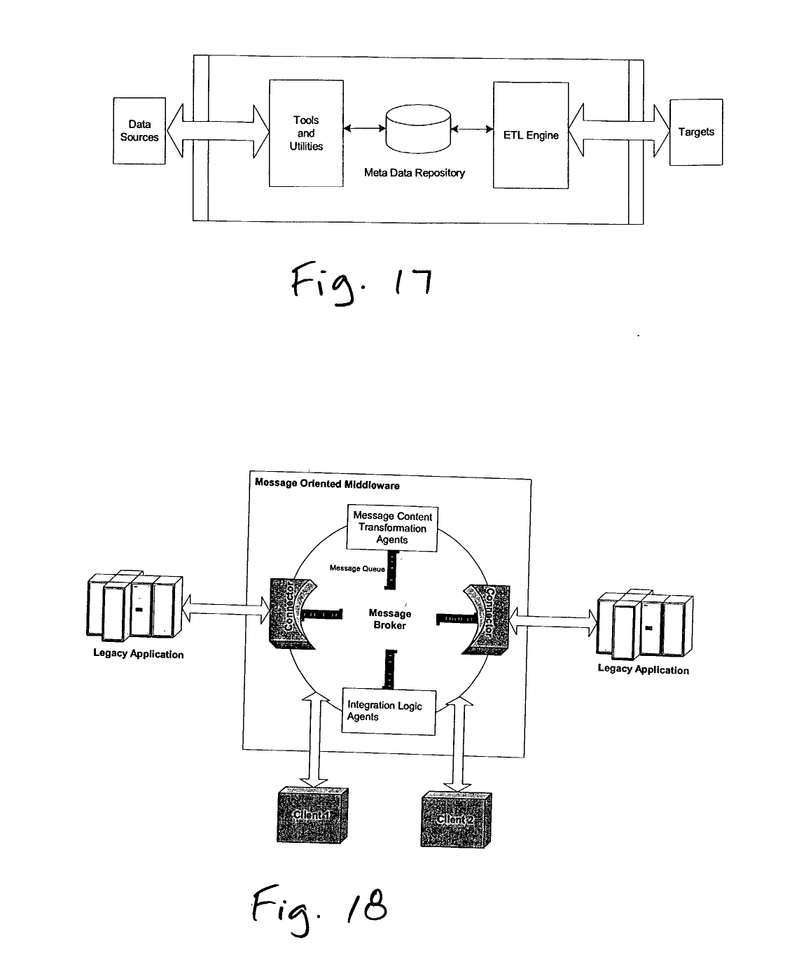

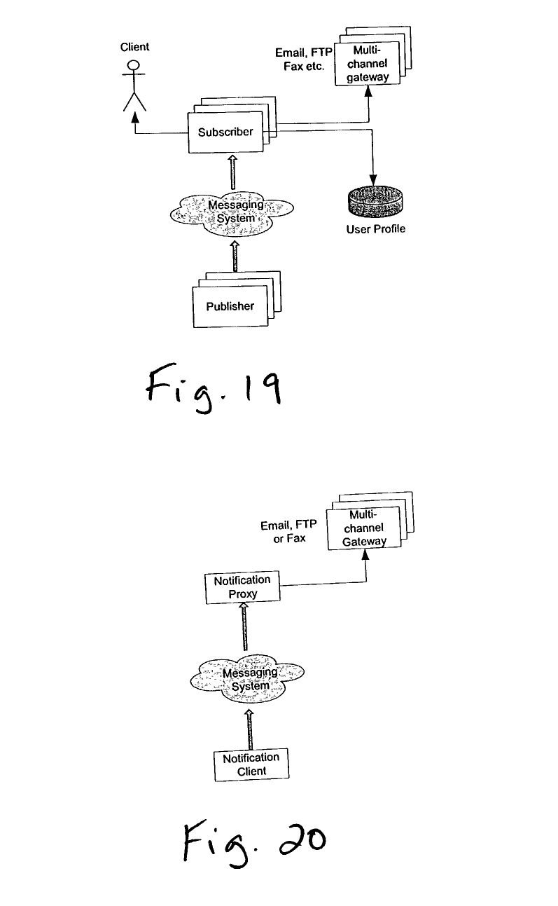

Referring to FIG. 14, there is shown a simplified block diagram illustrating an exemplary architecture of the data management subsystem 20. The data warehouse integrates with the ETL, OLAP, and a number of analytic services.

Referring to FIG. 15, there is shown a simplified block diagram representing a basic component interaction model illustrating how the data warehouse is populated. The data warehouse is typically populated through ETL processes. The diagram above explains this process. A scheduled job is run to initiate an extract from an operational data store and a load of an operational data warehouse. The ETL process extracts the required data from the operational data store. The ETL process translates the data to the desired format and loads it into the operational data warehouse.

Referring to FIG. 16, there is shown a simplified block diagram representing a basic component interaction model illustrating how a data request is satisfied. The user requests to see a report, chart, or graph from the data warehouse. The application server then talks with the OLAP server to retrieve the chart, graph, or cube. The OLAP server takes the request and decides how to gather the information from the data warehouse. The OLAP server receives the data from the data warehouse and begins to format it for presentation. The OLAP server transmits the formatted data to the application server. The application server transmits the formatted data to the user. The data warehouse is typically accessed through ODBC, JDBC, and native database drivers.

5.2 OLAP

The purpose of OLAP is to solve the “why” question when processing information. OLAP enables analysts, managers, and executives to gain insight into data through fast, consistent, interactive access to a wide variety of possible views of information. Technically, it designates a category of applications and technologies that allows the collection, storage, manipulation and reproduction of multidimensional data, with the goal of analysis.

In contrast to the data warehouse, which is usually based on relational technology, OLAP uses a multidimensional view of aggregate data to provide quick access to strategic information for further analysis. OLAP transforms raw data so that it reflects the real dimensionality of the enterprise as understood by the user.

The design of an OLAP server and the structure of the data are optimized for rapid ad-hoc information retrieval in any orientation, as well as for fast, flexible calculation. The OLAP server may either physically stage the processed multi-dimensional information to deliver consistent and rapid response times to end users, or it may populate its data structures in real-time from relational or other databases, or offer a choice of both. OLAP can be further divided into 4 categories:

Application OLAP

MOLAP

DOLAP

ROLAP

Application OLAP

Application OLAP products are sold either as complete applications, or as very functional, complete toolkits from which complex applications can be built. Nearly all application OLAP products include a multidimensional database, although a few also work as hybrid or relational OLAPs.

MOLAP

MOLAP (Multidimensional database OLAP) includes products than can be bought as unbundled, high performance multidimensional or hybrid databases. These products do not handle applications as large as those that are possible in the ROLAP products.

DOLAP

DOLAP (Desktop OLAP) is a client-based OLAP product that is easy to deploy and has a low cost per seat. DOLAP normally has good database links, often to both relational as well as multidimensional servers, as well as local PC files. DOLAP is not normally necessary to build an application. DOLAP usually has very limited functionality and capacity compared to the more specialized OLAP products. The web versions of desktop OLAPs include a mid-tier server that replaces some or all of the client functionality.

ROLAP

ROLAP (Relational OLAP) is the smallest of the OLAP sectors. The ROLAP products draw all their data and metadata in a standard RDBMS, with none being stored in any external files. They are capable of dealing with very large data volumes, but are complex and expensive to implement, have a slow query performance and are incapable of performing complex financial calculations. In operation, they work more as batch report writers than interactive analysis tools. They are suitable for read-only reporting applications.

In one exemplary embodiment, the OLAP service provided by the data management subsystem 20 has the following characteristics:

Drill-down—the ability to selectively see increasing levels of detail

Drill-up—the opposite of drill-down, i.e., the ability to group items to see less detail

Drill-across—the ability to expand detail along a horizontal axis

Drill-through—the ability to show more detail about an item

Trending—performing trend analysis when time is one of the dimensions in the data warehouse

It should be noted that the above characteristics are non-exhaustive and that this service may include one or more of these characteristics as well as other additional ones. A person of ordinary skill in the art will understand the various combinations of the characteristics that may be associated with this service.

Various products are available which offer OLAP, with product vendors creating their own respective designs and implementations. Some of the products that are currently available on the market include, for example, Cognos, Microstrategy, Microsoft SQL Server Analysis Services. A person of ordinary skill in the art should be familiar with the various technologies that are related to OLAP as described above. Based on the disclosure provided herein, a person of ordinary skill in the art should be able to select and/or customize various currently available OLAP products for integration and use as part of the system 10 in accordance with the present invention.

5.3 Statistics/Data Mining Service

Data mining means finding patterns in data which can be used to better conduct business. Its intent is to tell the user what may happen, and/or tell the user something interesting. In the latter case, data mining retrieves other information related to the discovered pattern that might be significant. Some people use the term “knowledge discovery” instead of data mining. Both describe the process of discovering a non-obvious pattern in data that can be used to for making better business decisions. Data mining has its roots in statistical techniques and artificial intelligence research.

The only real prerequisite for data mining is a business problem plus relevant data. So data mining can be carried out on any data source. However, pattern finding is very demanding of computer power so it is unusual to mine the operational database directly. Instead, mining is carried out on a data warehouse. It is also common for data mining to require, or benefit from, additional data. This is often brought-in geo-demographic or customer lifestyle data, which is combined with the organization's data about their own customers' behavior.

Successful data mining requires both business knowledge and some analytical ability. Business knowledge is usually the most crucial, as it and common sense can go a long way toward steering the user into reasonable use of data mining tools.

In one exemplary embodiment, the data mining service provided by the data management subsystem 20 has the following characteristics:

Classification Data Patterns: “To which set of predefined categories does this case belong?” In marketing, the categories may simply be the people who will buy and the people who will not buy. In health care, they may be high-risk and low-risk patients.

Association Data Patterns: “Which things occur together?” For example, looking at shopping baskets you may find that people who buy beer tend also to buy nuts at the same time.

Sequence: is essentially a time-ordered association, although the associated events may be spread far apart in time. For example, you may find that after marriage, people buy insurance.

Clustering or Segmentation: is like classification except that the categories are not normally known beforehand. You might look at a collection of shopping baskets and discover that there are clusters corresponding to health food buyers, convenience food buyers, luxury food buyers and so on.

Predictive Results: searches are made through large volumes of data in order to predict what may happen based on the information found.

Discovery-oriented Results: results are produced that specifically match a question that has been asked.

It should be noted that the above characteristics are non-exhaustive and that this service may include one or more of these characteristics as well as other additional ones. A person of ordinary skill in the art will understand the various combinations of the characteristics that may be associated with this service.

Various products are available which offer data mining, with product vendors creating their own respective designs and implementations. Some of the product vendors that offer data mining products include, for example, SPSS and HNC. A person of ordinary skill in the art should be familiar with the various technologies that are related to data mining as described above. Based on the disclosure provided herein, a person of ordinary skill in the art should be able to select and/or customize various currently available data mining products for integration and use as part of the system 10 in accordance with the present invention.

5.4 ETL Service

The ETL service provides bulk data sharing and data integration to various applications in the system 10. The ETL service provides a solution to handle multiple sources to multiple target data movement challenges that exists within an organization. The ETL service provides an environment to extract source records, applies logical transformations on the extracted data and creates records into the target database. The ETL service focuses on bulk data movement from one platform to other platform, applies all required transformation and utilizes the bulk loading facility of the database to load the data directly into the database. The ETL service is driven based on previously captured metadata information about the sources, targets and transformations. GUI utilities that are part of the ETL service let the developer create source to target mappings and provides a mechanism to apply the required transformations to the source data. This helps in achieving a consistent, consolidated and more productive approach to solve the data movement problems. As most of the common basic transformations are available as part of the ETL service, very minimal coding effort is required to deploy the ETL service.

Referring to FIG. 17, there is shown a simplified block diagram illustrating an exemplary ETL architecture. In one exemplary embodiment, the ETL service provided by the database management subsystem 20 has the following characteristics:

Heterogeneous source support including any type of flat files, hierarchical files and Legacy files

Heterogeneous relations database(s) support via native methods and industry standard connectivity (ODBC, JDBC) interfaces

Support for XML sources

Support for FTP bases sources

Provide support for legacy systems using plug-in components

Provide strong GUI capabilities to develop and operate different components of the tool

Flexibility to change application components with very minimal time and cost

Capability to apply translations and transformation using open metadata repository

Support scalar and vector level translation, transformation and transaction

Ability to define alternate path of execution to implement conditional transformations or to reject the data into an error bucket

Ability to apply pre-developed non-native (3GL, Java, C++) transformation as part of the transformation process

Ability to perform versioning through native mechanisms and through third party source code control systems like PVCS or Clear case is a must for large development requirements and for large organizations

Support for full system development and deployment life cycle

Interface with Industry standard scheduling software for easy deployment and O&M

Support for system monitoring tools for operations and other statistical requirements

It should be noted that the above characteristics are non-exhaustive and that this service may include one or more of these characteristics as well as other additional ones. A person of ordinary skill in the art will understand the various combinations of the characteristics that may be associated with this service.

Various products are available which offer ETL service, with product vendors creating their own respective designs and implementations. Some of the product vendors that offer ETL products include, for example, Informatica, Ab Initio and Ascential Software Datastage and Metastage. A person of ordinary skill in the art should be familiar with the various technologies that are related to the ETL service as described above. Based on the disclosure provided herein, a person of ordinary skill in the art should be able to select and/or customize various currently available ETL products for integration and use as part of the system 10 in accordance with the present invention.

6. Enterprise Application Integration

The enterprise application integration subsystem 22 provides reliable, expandable, and secure application interactions using a number of communication protocols. The exact mechanism to be used to communicate with a given application or service is hidden by the use of integration layers, which provide an abstract means for requesting services. The enterprise application integration subsystem 22 includes a number of services or components including, messaging service, publish/subscribe and notification service, transaction processing service, integration adapters, CORBA transport service and legacy gateway service, each of which is further described below.

6.1 Messaging Service

The messaging service decouples interacting applications. This allows for greater flexibility in the system 10 and keeps the inter-dependencies to a minimum. For example, a front-office application can continue to operate even if the back-office application is momentarily down. In one exemplary embodiment, the messaging service provided by the enterprise application integration subsystem 22 has the following characteristics:

Support queuing and communication models like request/reply, publish/subscribe etc.

Support for guaranteed delivery of messages

Provision to prioritize the message processing

Provide out of the box adapters for back office and legacy applications

Distribute load without major configuration changes

Provide services/tools for rapid implementation of message content transformations and intelligent routing of messages

Support for digital certificates and SSL security for data transmitted

Support for transactions, with middleware supporting the capability to define units of work (i.e., if a set of messages grouped into a single unit of work are in the queue and if one of the messages being processed fails, then all the remaining messages for that unit of work are to be retained in the queue by the middleware)

It should be noted that the above characteristics are non-exhaustive and that this service may include one or more of these characteristics as well as other additional ones. A person of ordinary skill in the art will understand the various combinations of the characteristics that may be associated with this service.

Referring to FIG. 18, there is shown a simplified block diagram illustrating an exemplary architecture of a messaging service system.

Messaging Broker

This layer is responsible for routing requests and replies to corresponding applications. It provides the underlying framework for request/reply and publish/subscribe functionality and queue management functionalities. The message interface defines and maintains the format of the messages exchanged between the applications.

Connector

A connector module is the interface for existing applications to communicate with the middleware. Middleware products typically provide connectors for popular packaged applications. They also provides a set of libraries to build custom connectors for existing applications.

Integration Logic Agent

This is the module provided by popular middleware products for rapid implementation of the integration business rules and to provide intelligent routing capabilities. The implementation can be stateful or stateless.

Message Content Transformation Agent

This module helps implementing generic message marshalling capabilities, like date format changes, currency conversions, changing text formats etc. It could be shared across applications. This is powerful when integrating existing applications as no code modifications are required to the legacy applications.

Clients

Clients are the applications that need to communicate with the back-end legacy systems. The middleware offers API's that the clients can use.

Message Queue

This is a queuing mechanism implemented by the middleware. The middleware maintains a queue for each application listening on the broker. Interacting applications communicate by placing messages on each other's queue. As a result applications can run fairly independent of each other.

Various products are available which offer messaging service, with product vendors creating their own respective designs and implementations. One such product includes, for example, the IBM MQ Series. A person of ordinary skill in the art should be familiar with the various technologies that are related to the messaging service as described above. Based on the disclosure provided herein, a person of ordinary skill in the art should be able to select and/or customize various currently available messaging service products for integration and use as part of the system 10 in accordance with the present invention.

6.2 Publish/Subscribe and Notification Service

The publish/subscribe service provides an end-to-end delivery mechanism of content. This service requires the receiver of the content to subscribe to a content topic or type. The notification service is a one-way publishing mechanism and does not require the receiver's subscription. Although the definitions are different, both services share a very similar architecture. Due to the similarity, many vendors define the publish/subscribe service and notification service to be the same.

6.2.1 Publish/Subscribe Service

The publish/subscribe service is divided into two categories:

Subject-Based Messaging

Subject-based systems support messages that belong to one of a fixed set of subjects (also known as groups, channels, or topics) in subject-based systems. With this type of service, publishers are required to label each message with a subject, and consumers subscribe to all the messages within a particular subject.

Content-Based Messaging

Content-based systems support a number of information spaces. Subscribers may express a “query” against the content of messages published.

An example of the usage of the publish/subscribe service is the delivery of transaction reports. There are millions of transactions carried out using Visa USA cards. Many banks are associated with all of these daily transactions. For example, some member banks need to have a daily transaction report or some may need to know promotions offered by Visa USA. These banks subscribe themselves to their respective interest (promotions and/or daily transaction report). Whenever a publisher generates these transaction reports, they are pushed to subscribers via a messaging system. The subscriber forwards these reports to clients/member banks via a Multi-Channel Gateway Service (e-mail, fax, or FTP).

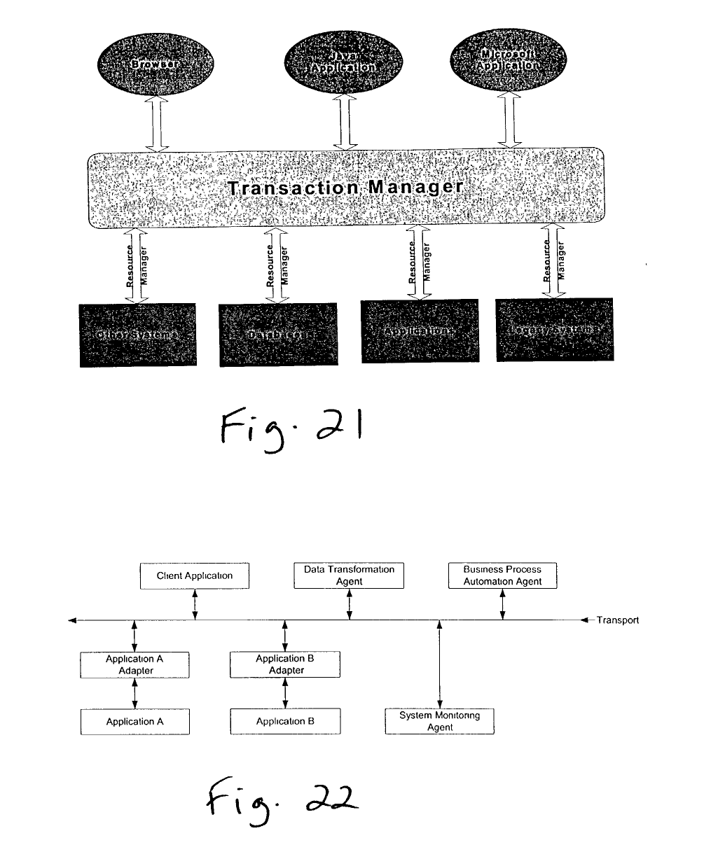

Referring to FIG. 19, there is shown a simplified block diagram illustrating an exemplary architecture of publish/subscribe service.

Publisher

The provider of the information is called a publisher. Publishers supply information about a subject, without the need to know anything about the applications interested in the information.

Subscriber

The consumer of the information produced by the publisher is called a subscriber. Subscribers receive information, from many different publishers. In addition, the information they receive can also be sent to other subscribers. From the system perspective, the subscribers are applications.

Messaging System

The messaging system is responsible for distributing published information. This information is forwarded (or pushed) based on subscriptions by clients.

Multi-Channel Gateway

The multi-channel gateway 12, as described above, is used as the delivery mechanism across various entities.

User Profile

Subscribers consult data stores for personalization.

6.2.2 Notification Service

Notifications occur as the result of an event. The event may be a system event, such as the addition or failure of a component, or a business event, such as the posting of a particular transaction. Various types of notification could be informational notifications like, “Your login was successful”, alert notifications like, “Your conference call is due in five minutes” or workflow notifications like, “Please approve invoice #X”. Notifications are generated by software applications after the event that triggers the notification has been recorded. Notifications are typically not context-rich; they only provide information specific to the notification event. It is typically a small message, however it can initiate a new business process.

Referring to FIG. 20, there is shown a simplified block diagram illustrating an exemplary architecture of the notification service. The messaging system is the core communication channel between the notification client and the notification proxy.

Notification Client

The notification client initiates notification messages. These messages may be based on some events that occurred in the system. They may be alert notifications, assistance notifications, workflow notifications and/or several other notifications.

Messaging System

The messaging system is responsible for distributing notification messages. The notification proxy subscribes to messages and delivers them to their destinations.

Notification Proxy

The notification proxy is in charge of sending notification messages to the application processes. These processes forward notifications to relevant applications that may start a new business process. The multi-channel gateways are used to distribute these messages.

Multi-Channel Gateways

The multi-channel gateways 12, as described above, deliver notifications to the end users.

Various products are available which offer publish/subscribe and notification services, with product vendors creating their own respective designs and implementations. Some of the products include, for example, BEA WebLogic Notification Service and TIBCO. A person of ordinary skill in the art should be familiar with the various technologies that are related to the publish/subscribe and notification services as described above. Based on the disclosure provided herein, a person of ordinary skill in the art should be able to select and/or customize various currently available publish/subscribe and notification products for integration and use as part of the system 10 in accordance with the present invention.

6.3 Transaction Processing Service

A transaction is formally defined as an atomic unit of work. Multiple operations can be included in one transaction. When the transaction is terminated, all changes performed by the operations are either applied or undone as a whole. In one exemplary embodiment, the transaction processing service provided by the enterprise application integration subsystem 22 has the following characteristics:

Atomic—A transaction should be a discrete unit of work. All operations involved in the transaction should work as a whole.

Consistent—The system is in a consistent state, before the transaction and after the end of the transaction.

Multiple Transaction support with Isolation—Each transaction is executed independently. The behavior of one transaction does not affect other transactions or shared resources being used by other transactions.

Durable—At the end of a transaction, the results are permanent and durable, leaving the system in a stable state.

Highly Available

Scalable

It should be noted that the above characteristics are non-exhaustive and that this service may include one or more of these characteristics as well as other additional ones. A person of ordinary skill in the art will understand the various combinations of the characteristics that may be associated with this service.

Referring to FIG. 21, there is shown a simplified block diagram illustrating an exemplary architecture of the transaction processing service.

Distributed Transaction Processing (DTP) Model

Most of the transaction enabled applications follow the x/Open Distributed Transaction Processing (DTP) model. Almost all vendors developing products related to transaction processing, relational databases and message queuing support this architecture. This model defines three components: application programs, resource managers, and a transaction manager, which is usually some high performance transaction supporting application. Each of these components is briefly explained below:

Application Programs

These are the programs with which application developers use to implement transactions. These programs are responsible for initiating transactions and taking decisions to commit or rollback the transactions. They access the transactional resources through the transaction manager within the context of each transaction.

Transaction Manager

The transaction manager acts as the core component of a transaction-processing environment. It creates transactions when requested by application programs, tracks the availability of resources and implements the two-phase commit/recovery protocol with resource managers. It establishes and maintains a transaction context for each transaction created. It also maintains the association between a transaction and the resources participating in that transaction.

Resource Manager

The resource manager is a component that manages the resources taking part in transactions. It enlists and de-lists the resources with the transaction manager so it can keep track of the availability of the resources. The resource manager participates in two-phase commit and recovery in association with the transaction manager. In a typical storage environment, for example, you can think of a resource manager as a driver for a database.

Two Phase Commit

Two phase commit is not a component in a transaction processing system but it is an important mechanism to ensure the transaction integrity. This is actually a protocol implemented between the transaction manager and all the resources taking part in transactions, that either all the resource managers for these resources commit the transaction or they all roll back. In this protocol, when the application program issues a commit request, the transaction manager issues a prepare-commit request to all the resource managers. If all the resource managers are ready to committed, only then the transaction is committed otherwise it is rolled back to its original state.

The DTP Model specifies functional interfaces between application programs and the transaction manager. These interfaces are known as TX interfaces. DTP also specifies the interfaces between the transaction manager and the resource managers, which is known as XA interfaces. With products complying with these interfaces, one can implement transactions with the two-phase commit and recovery protocol to preserve atomicity of transactions.

In a J2EE environment, JTAPI (Java Transaction API) is most widely used for integration. This API provides interfaces for the transaction manager, the resource manager and the application programs. Other than JTAPI, products have their own APIs provided for integration.

Various products are available which offer transaction processing services, with product vendors creating their own respective designs and implementations. Some of the products include, for example, BEA Tuxedo, IBM Encina and Microsoft Transaction Server (MTS). A person of ordinary skill in the art should be familiar with the various technologies that are related to the transaction processing service as described above. Based on the disclosure provided herein, a person of ordinary skill in the art should be able to select and/or customize various currently available transaction processing products for integration and use as part of the system 10 in accordance with the present invention.

6.4 Integration Adapters

One of the most useful components of EAI technologies are the various kinds of integration, translation, reformatting and adapter technologies available in the larger software platforms and in a large number of special purpose technologies. In one exemplary embodiment, the integration adapters provided by the enterprise application integration subsystem 22 have the following characteristics:

Support for cross-platform application integration.

Support for synchronous and asynchronous communications between applications.

A messaging framework that supports:

A JMS compliant message queue.

Guaranteed delivery of messages.

Provision for prioritizing the processing of messages in the message queue.

A scalable architecture that can distribute the message load without major configuration changes.

Encryption of transmitted data using SSL and digital certificates.

Ability to define basic transactions for point-to-point communication. That is: if a set of messages are grouped into a single transaction in the message queue and if one of the messages being processed fails then all the remaining messages are be cleared from the message queue by the middleware.

Provide out of the box adapters for many of the back office and legacy applications at Visa USA.

Services/tools for rapid implementation of message content transformations and intelligent routing of messages.

Services that enable business process automation across applications.

User-friendly administrative tools to configure and maintain the systems.

Support for distributed transactions.

It should be noted that the above characteristics are non-exhaustive and that the integration adapters may include one or more of these characteristics as well as other additional ones. A person of ordinary skill in the art will understand the various combinations of the characteristics that may be associated with the integration adapters.

Referring to FIG. 22, there is shown a simplified block diagram illustrating an exemplary architecture of an EAI framework. The EAI infrastructure products identified are required to realize the EAI design patterns to architect a flexible and reliable EAI infrastructure.

Transport

The transport is the middleware's backbone process responsible for providing reliable communication between cross-platform applications. The transport defines a common message format to enable platform-independent application interactions.

Application Adapters

The adapter is the interface to make applications available over the transport. Middleware vendors provide a number of adapters for common front and back office systems. The middleware commonly ships with an Adapter Development Kit (ADK) to enable custom adapter development. The adapters are responsible for translating messages from application-specific format to messaging layer-specific format and vice versa.

Data Transformation Agents

The data transformation agents provide rule-based data transformation and validation, to resolve differences in data formats and data models between communicating applications. A data transformation agent helps prevent a tightly coupled integration between applications.

Business Process Automation

This is a workflow product commonly provided by middleware vendors. The business processes that span multiple applications can be automated using this product. These products provide intuitive user interfaces for defining and monitoring the states of processes. This makes centralized management of business processes possible. It also helps gauge and identify business process improvements.

System Monitoring

This is an agent offered by middleware vendors that enables monitoring of applications on the middleware and provides the capability to define corrective actions.

Various products are available which offer EAI tools, with product vendors creating their own respective designs and implementations. Some of the products include, for example, MQSeries, SeeBeyond, TIBCO and WebMethods. A person of ordinary skill in the art should be familiar with the various technologies that are related to EAI tools as described above. Based on the disclosure provided herein, a person of ordinary skill in the art should be able to select and/or customize various currently available EAI tools for integration and use as part of the system 10 in accordance with the present invention.

6.5 CORBA Transport Service

The Common Object Request Broker Architecture (CORBA) is an open distributed object computing infrastructure being standardized by the Object Management Group. CORBA automates many common network programming tasks, such as, object registration, location, and activation; request demultiplexing; framing and error-handling; parameter marshalling and demarshalling; and operation dispatching. There are many ways to use CORBA. In one exemplary embodiment, COBRA is used within the system 10 as a transport service for communication with legacy systems.

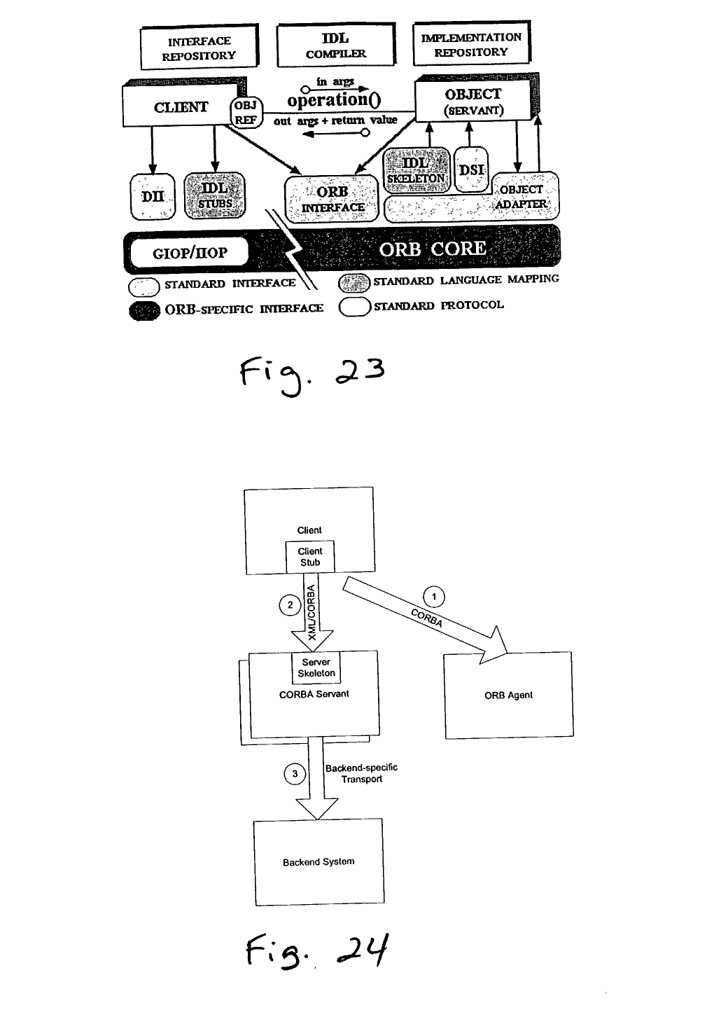

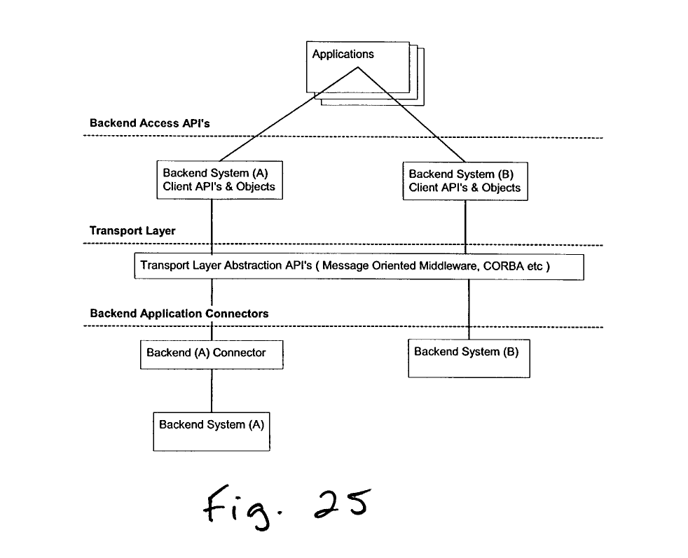

In order to understand how CORBA can be used as a transport layer, one needs to know the basic concept of CORBA. Referring to FIG. 23, there is shown a simplified block diagram illustrating components of a CORBA architecture.

Object

An object is defined as an identifiable, encapsulated entity that provides one or more services that can be requested by a client. In CORBA, an object is an entity that consists of an identity, an interface, and an implementation.

Servant

This is an implementation programming language entity that defines the operations that support a CORBA IDL interface. Servants can be written in a variety of languages, including C, C++, Java, Smalltalk, and Ada.

Client

This is the program entity that invokes an operation on an object implementation. Accessing the services of a remote object is transparent to the caller.

Object Request Broker (ORB)

The ORB provides a mechanism for transparently communicating client requests to target object implementations. The ORB decouples the client from the details of the method invocations, thus makes client requests appear to be local procedure calls. When a client invokes an operation, the ORB is responsible for finding the object implementation, transparently activating it if necessary, delivering the request to the object, and returning any response to the caller.

ORB Interface

An ORB is a logical entity that may be implemented in various ways (such as one or more processes or a set of libraries). To decouple applications from implementation details, the CORBA specification defines an abstract interface for an ORB. This interface provides various helper functions, such as, converting object references to strings and vice versa, and creating argument lists for requests made through the dynamic invocation interface described below.

CORBA IDL Stubs and Skeletons

CORBA IDL stubs and skeletons serve as the “glue” between the client and server applications and the ORB. A CORBA IDL compiler automates the transformation between the CORBA IDL definitions and the target programming language. The use of a compiler reduces the potential for inconsistencies between client stubs and server skeletons and increases opportunities for automated compiler optimizations.

Dynamic Invocation Interface (DII)

This interface allows a client to directly access the underlying request mechanisms provided by an ORB. Applications use the DII to dynamically issue requests to objects without requiring IDL interface-specific stubs to be linked in. Unlike IDL stubs (which only allow RPC-style requests), the DII also allows clients to make non-blocking deferred synchronous (separate send and receive operations) and one-way (send-only) calls. Dynamic Skeleton Interface (DSI)

This is the server side's analogue to the client side's DII. The DSI allows an ORB to deliver requests to an object implementation that does not have compile-time knowledge of the type of the object it is implementing. The client making the request has no idea whether the implementation is using the type-specific IDL skeletons or is using the dynamic skeletons.

Object Adapter

This assists the ORB with delivering requests to the object and with activating the object. More importantly, an object adapter associates object implementations with the ORB. Object adapters can be specialized to provide support for certain object implementation styles (such as OODB object adapters for persistence and library object adapters for non-remote objects).

GIOP/IIOP

The General Inter-ORB Protocol (GIOP) specified files transfer syntax and a standard set of message formats for ORB interoperation over any connection-oriented transport. The Internet Inter-ORB Protocol specifies how GIOP is build over TCP/IP transport.

In one exemplary embodiment, the CORBA transport service as implemented under the system 10 has the following characteristics:

Enable heterogeneous distributed computational components to communicate

Handle various communication protocols between components

Encapsulate object location, implementation, execution state, and communication mechanism so that the client has a simplified interface to access back-end objects

Provide reliable, expandable, and secure data access

It should be noted that the above characteristics are non-exhaustive and that this service may include one or more of these characteristics as well as other additional ones. A person of ordinary skill in the art will understand the various combinations of the characteristics that may be associated with this service.

Referring to FIG. 24, there is shown a simplified block diagram illustrating how CORBA is used as transport in integration with legacy systems. The client invokes the ORB agent for binding to an instance of the servant. There may be a number of servants running. The ORB agent selects a servant based on a predefined load-balancing scheme. The client can hold the binding for subsequent requests. The client serializes the request into a particular message. XML is usually used for the message format. It sends the message to the servant through a client stub. The servant receives the request in XML format and de-serializes it into a tree structure. It then invokes the backend system with information in the tree. When a response comes back from the backend system, the servant constructs an XML response message and returns it to the client.

The CORBA transport service can be used by a data access service or other services. There are two integration points: client-side API and server-side implementation.

Client-Side API

Client-side API is an interface used by a client service or application in the system 10 for submitting requests and receiving responses. If the clients are in different languages, the IDL itself can be exposed as the interface. If Java is used, a Java API is written to shield the IDL from the client. A common protocol for message format (e.g. XML) is defined for generalizing serialization and de-serialization of messages.

Server-Side Implementation

Server-side Implementation interprets incoming requests, invokes the backend systems, and returns responses. It usually ties to a particular backend system because business logic is needed to convert requests from XML to backend-specific format. However, sometimes there are objects that can be reused (e.g. code for serializing XML messages).

6.6 Legacy Gateway Service

The legacy gateway service provides access to backend systems. Since each backend system has a different architecture, it is not feasible to assume this type of service can be constructed with the same structure and COTS products. In one exemplary embodiment, the legacy gateway service provided by the system 10 has the following characteristics:

Highly modular

Scalable

Highly available

Secure data transmission

Reliable data transmission

It should be noted that the above characteristics are non-exhaustive and that this service may include one or more of these characteristics as well as other additional ones. A person of ordinary skill in the art will understand the various combinations of the characteristics that may be associated with this service.

Referring to FIG. 25, there is shown a simplified block diagram illustrating an exemplary architecture of the legacy gateway service. The integration platform has three levels of abstraction for interaction between service requesting applications and service processing applications. This is to maintain a highly scalable and flexible architecture.

Backend Access API's Layer

This layer maintains a collection of generic API's for each backend application that needs to be integrated.

Keep client application requirements out these services

Provide specific methods/interfaces for submitting requests to the backend application.

Responsible for meeting message-formatting requirements of the transport layer.

Support callback method interfaces. Business logic in the callback depend on the application using these API's.

Transport Layer

This layer provides all transport layer specific utilities like connection pool management, queuing and load balancing across backend connectors. This layer provides:

Connection pool management

Queue management services

Load balancing/monitoring services

Guarantied message delivery

Provide callback support to listening applications

Secure data transmission

Backend Application Connector Layer

Depending on the complexity of the integration to the backend application, there could be the need for providing connectors that do backend specific processing of requests. This layer provides:

Connection pool management to the backend system

Transport layer specific message packing/unpacking

Provide backend system specific message packing/unpacking

Implement business logic specific to the backend system

Other services and applications can use the legacy gateway service by calling its backend access API. Typically, such an API is composed of two sets of classes:

Java API's library set for use by other Applications for submitting requests to the service

Register a callback function with this service for processing incoming data from the data source to allow data to be returned asynchronously

The legacy gateway service usually is custom-built with some COTS products, for example, VTRS uses Mobius's DocumentDirect. Based on the disclosure provided herein, a person of ordinary skill in the art should be able to select and/or customize various currently available commercial products for integration and use as part of the system 10 in accordance with the present invention.

6.6.1 VTRS Service

In one exemplary embodiment, a VTRS service is implemented using the legacy gateway service. VTRS is the repository for all original and authorization transactions of a credit card association, such as, Visa. The objective is to provide a generic and scalable interface to VTRS. Other system applications will use this interface to query transactions from VTRS.

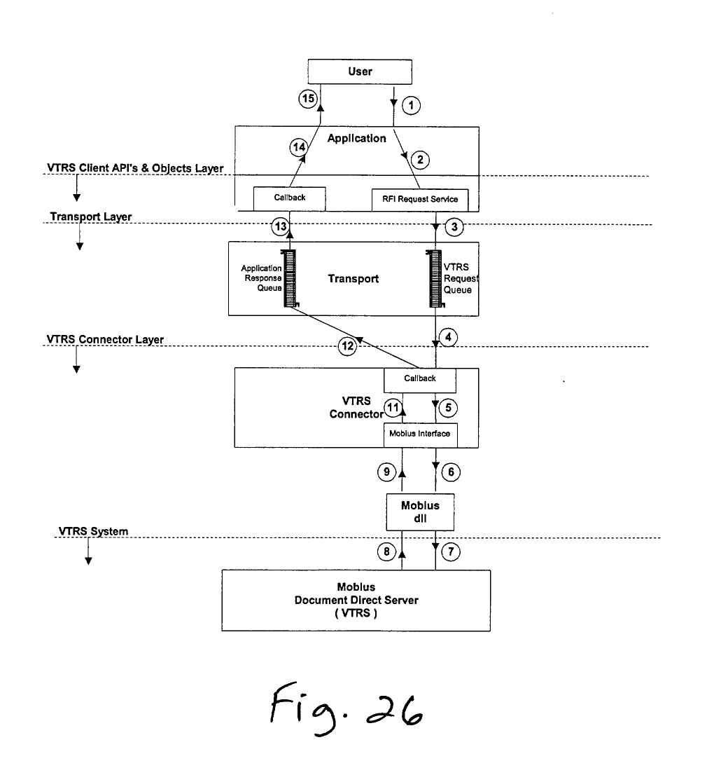

Referring to FIG. 26, there is shown a simplified block diagram illustrating an exemplary architecture of the VTRS service.

VTRS Client API's And Object Layer

Provide an interface for submitting an RFI request. Implement a generic interface with support for specifying the list of fields to fetch from VTRS and variable set of search criteria.

Provide support for receiving response from VTRS asynchronously. Common solutions are to implement a callback or maintain a polling mechanism. The system provides support for load balancing, in the transport layer, across multiple registered callbacks.

Implementation of this layer is dependent on the transport layer implementation.

Meet the transport layers message packing and unpacking requirements.

Transport Layer

A Message Oriented Middleware (MOM), CORBA or RPC are the alternatives for implementing this layer. Considering the present response times of VTRS and the Mobius Interface, it is recommended to implement an asynchronous messaging layer. The MOM product integration is easy to maintain, flexible, scalable and reliable integration platform with fewer network sessions.

The choices of MOM products are MQ Series and WebMethods.

Ability to balance load across VTRS connectors.

Guarantied delivery of messages

Should support cluster configuration of the transport middleware for high availability

VTRS Connector Layer

Meet the message packing and unpacking requirements of the transport layer.

Provide the message packing and unpacking requirements of the Mobius Interface.

Efficiently handle the buffer size and date range search limitations of Mobius.

Ability to restart a connector after a failure.

Other services and applications can use VTRS Client API to submit requests to the VTRS service. Callback classes are provided to receive and process responses returned asynchronously by the service.

7. Auxiliary Services

The auxiliary services subsystem 24 includes common facilities that can be shared across all applications within the system 10. The auxiliary services subsystem 24 includes a number of services or components including audit trail, logging and scheduler services, each of which is further described below.

7.1 Audit Trail Service

The audit trail service builds traceability and accountability into applications. Data tracked by audit trail includes user login and logout, transactions, user actions in the web site. This data is collected and analyzed by business analysts. Sometimes they are even used for real-time targeting. In one exemplary embodiment, the audit trail service provided by the system 10 has the following characteristics:

Log significant business event and data

Need structured form of data storage for reporting and analysis

Information logged sometimes used for personalization

It should be noted that the above characteristics are non-exhaustive and that this service may include one or more of these characteristics as well as other additional ones. A person of ordinary skill in the art will understand the various combinations of the characteristics that may be associated with this service.

Referring to FIG. 27, there is shown a simplified block diagram illustrating an exemplary architecture of the audit trail service. Information recorded by the audit trail service is used for business purposes like marketing, compliance and sales while the logging service, as further described below, logs systematic information for system support and tuning. Like the logging service, the audit trail service lives inside the application server. Architecturally if the logging service is flexible enough, the audit trail service can usually invoke it. Different business events can be defined for creating an audit trail. Each event records different user data. These events are defined using property files, which are read by audit trail Java classes to record the events. Typically, records logged by the audit trail service are stored in an observation database. A daily batch job is required to roll the business records from this database into a data warehouse where analysis can be performed. The audit trail service uses Java classes for recording business events. Property files are needed to define these events.

7.2 Logging Service

The logging service provides system-level logging for applications or services in the system. It is used for debugging, system monitoring, production, maintenance, and performance measurement. Many COTS products and existing services produce their own logs. In one exemplary embodiment, the logging service provided by the system 10 has the following characteristics:

Support for different levels of logging

Support all necessary logging destinations

Implements log rotation when the logs are stored in files, as is often the case

Support for debugging and system monitoring

Aid in performance tuning

Should have a minimum impact on system performance

Scalable

Having an open architecture to integrate with other services/applications, such as monitoring services and notification applications

Administrative interface for dynamic modification of the logging configurations

It should be noted that the above characteristics are non-exhaustive and that this service may include one or more of these characteristics as well as other additional ones. A person of ordinary skill in the art will understand the various combinations of the characteristics that may be associated with this service.

Referring to FIG. 28, there is shown a simplified block diagram illustrating an exemplary architecture of the logging service. The logging service is implemented by using Java API's inside the application server, and its architecture comprises of LogEvents, Queues, Dispatchers and EventDestination.

LogEvent

To log a message, a component creates a LogEvent that includes the message, and then broadcasts the event. The LogListenerQueue receives LogEvents.

LogListenerQueue

This is a queue of log events from various components before sending them to their final destinations. This means that a component sending a log event is not held up waiting for the event to be written to disk. Instead, the event is sent to the queue, which later passes the event on to the listener that eventually writes it to the file. This allows a high-throughput process, such as HTTP request handling, to be decoupled from the slower logging processes such as writing to files or sending e-mail.

LogDispatcher

A log listener routes LogEvents to other LogEventSinks based on the types of those LogEvents. These LogEventDestinations may include components, which can send log events to files, database, console or e-mail. For example, it can be set to send ErrorLogs through e-mails, while all other log event types are sent to a file or database.

LogEventDestination

This is the component that performs a final action on a LogEvent. This may include writing the LogEvent to a file, sending the LogEvent as e-mail, writing the LogEvent to a database, or printing the LogEvent on console.

The benefit of this architecture design is that a log source does not need to know where its log messages are going, whether they are being queued, etc. Because the listeners can be defined in properties files, all of the decisions about logging can be left to configuration, while the log source only has to worry about generating and broadcasting logging messages.

The logging service exists as Java classes. Applications and services use it by simply calling those classes. The logging service utilizes some properties set, e.g., log level, which should be incorporated into the properties of the applications or services.

7.3 Scheduler Service

The scheduler service provides distributed job scheduling capability in the system environment. It has a GUI interface to control jobs at a single place. In one exemplary embodiment, the scheduler service provided by the system 10 has the following characteristics:

Ability to schedule jobs to run at certain times, in a specific order, and have varying levels of resource demands and prioritization.

Provide a reliable sequencing of batch program execution.

Implement proactive event management to coordinate all the widely distributed networked computing resources.

Flexible enough to accommodate varying technology, and business and resource demands.

Ability to account for both user security and provide protection against individual users taking unauthorized actions while using the tool.

Allow scheduling to continue even in the event of a network outage.

Resynchronize all nodes in the network in the event of a system or network failure.

It should be noted that the above characteristics are non-exhaustive and that this service may include one or more of these characteristics as well as other additional ones. A person of ordinary skill in the art will understand the various combinations of the characteristics that may be associated with this service.

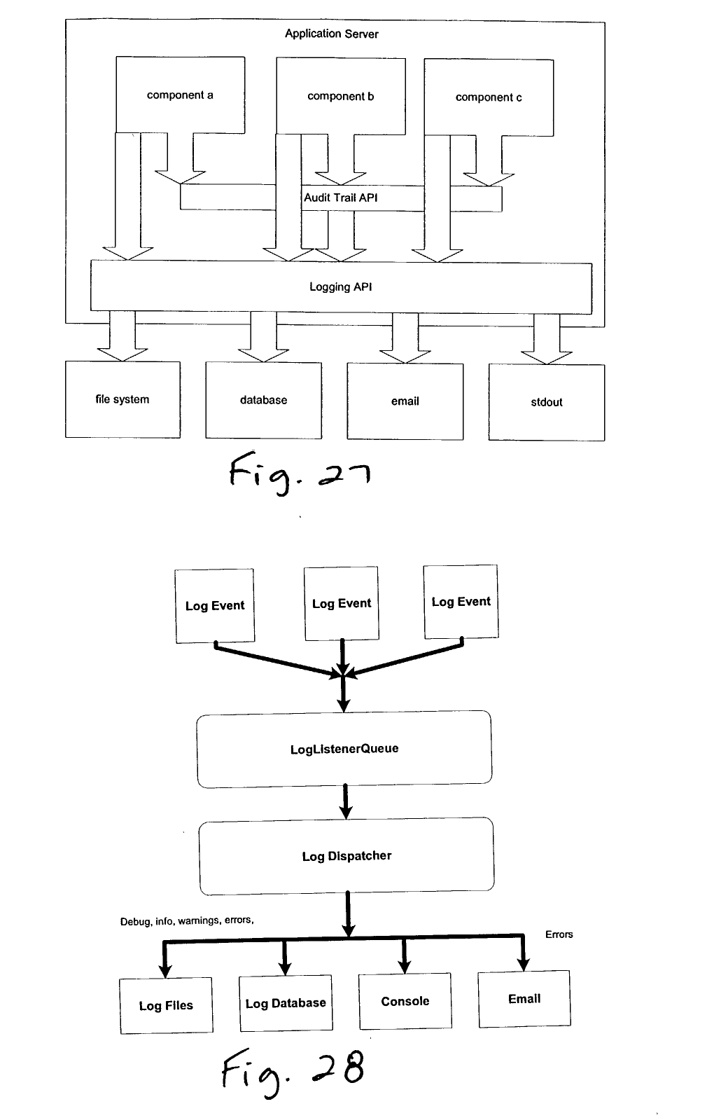

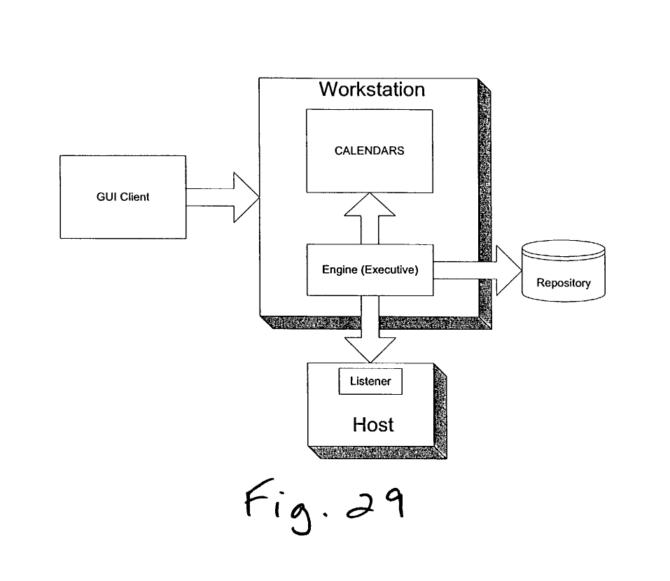

Referring to FIG. 29, there is shown a simplified block diagram illustrating an exemplary architecture of a scheduling system. One of the key components is a calendar that is configurable and is used to manage date-time. The calendar also helps to schedule jobs to run at certain times, in a specific order.

Workstation

Executive operates from within its web address called workstation. Executive schedules work based upon real time occurrence of system and job related events, time update and calendars. User defined job networks established the relationship between an event and a task. When all the required events have occurred and the relationships are satisfied, the task scheduled submits the job for execution. Multiple calendars may be defined for each workstation. Individual job schedule may be associated with specific calendar. Executive can run on a standalone system or on multiple systems and communicate via the multi-system option. Each system may utilize its own repository or the same. It is the root of the system and controls other nodes.

Calendar

Calendars are the basis for all scheduling relationships. A calendar is the physical implementation of the schedule concept. This concept includes relative schedule times such as every third Tuesday, the fourth-to-the-last workday, and the second Monday of every month. Whereas, a schedule can have virtual values, a calendar is fixed.

Client (GUI)

One common graphical user interface, the job-scheduling console, provides a focal point of control for scheduling engines, operation planning and control.

Repository

Job network and calendars definitions are stored in workstation repository. The history of all events, tasks and job execution are also stored in repository.

Listener

Listener is a process on a host that listens to request received from executive. After performing the required job according to request, it responses back to executive.

Host

Host, an enterprise distributed job scheduling system, operates over an operating system. It has a listener that listens to executive and spawns jobs on a particular operating system.

Various products are available which offer scheduling service, with product vendors creating their own respective designs and implementations. One such product includes, for example, Tivoli Maestro. A person of ordinary skill in the art should be familiar with the various technologies that are related to the scheduling service as described above. Based on the disclosure provided herein, a person of ordinary skill in the art should be able to select and/or customize various currently available scheduling products for integration and use as part of the system 10 in accordance with the present invention.

8. Performance Services

The performance subsystem 26 provides facilities to monitor and enhance the performance of the system 10 and the applications and services it supports. The performance subsystem 26 provides a number of services including performance management services and performance enhancement services.

8.1 Performance Management Services

The objective of the performance management services is to monitor and measure the performance of an application within the system, as well as the system and network platforms on which the application executes. It provides performance data at the component level, thus allowing debugging and tracking of performance problems. Another important function of the services is the collection and warehousing of performance data and presentation of statistical reports to interested parties. In addition, the data captured and summarized provides the information needed to create baselines for capacity forecasting and planning.

While these services provide information to operational monitoring services for purposes of generating performance/usage-related alerts, the primary focus is on the capture and use of historical data. The performance management services are further divided into the following areas:

Application monitoring and measurement data capture

Application-incorporated monitoring and measurement data capture

System/network monitoring and measurement data capture

Measurement data management

Historical performance reporting, base-lining and analysis support

8.1.1 Application Performance Data Capture

Application performance data capture, generally, can be achieved using external (to the infrastructure environment) services, vendor-provided products installed internally within the infrastructure environment, custom-tailored internally installed products or a combination of all these. In one exemplary embodiment, the application performance data capture service provided by the system has the following characteristics:

Complete suite of monitors that watch critical web environment components from both an internal and external perspective.

Centralized monitoring of a) large and small web server farms, b) application servers, c) database servers and d) operations and maintenance support servers.

Mechanism(s) for notifying operational monitoring and alerting service of conditions requiring alerts to be generated and/or action(s) to be taken.

Capture and logging of historical performance measurement data including but not limited to the following.

Business/user volumes such as pages/hour or hits/hour.

Specific performance metrics such as end-to-end response-time, component response-time and throughput.

Scheduled and on-demand management reports for trend analysis.

It should be noted that the above characteristics are non-exhaustive and that this service may include one or more of these characteristics as well as other additional ones. A person of ordinary skill in the art will understand the various combinations of the characteristics that may be associated with this service.

There are a few performance management service providers in the market that measure application performance from both inside and outside the corporate firewall. Some of the more familiar leaders in this field are Keynote Systems, Mercury/Freshwater Software, Candle Corporation and Tivoli. A person of ordinary skill in the art should be familiar with the various technologies that are related to the application performance data capture as described above. Based on the disclosure provided herein, a person of ordinary skill in the art should be able to select and/or customize various currently available commercial products for integration and use as part of the system 10 in accordance with the present invention.

8.1.2 System/Network Performance Data Capture

System/network performance data capture is focused on providing for the capture of historical measurement information required to support offline performance analysis and capacity planning. The type of operational monitoring that provides for real-time alerting and “machine room” troubleshooting support is further described below. In one exemplary embodiment, the system/network performance data capture provided by the system 10 has the following characteristics:

Capture historical measurement data for servers and the processes running thereon.

Capture historical measurement data for the device components (e.g., routers, switches, firewalls) and server components (e.g., DNS, LDAP) of the network infrastructure.

Provide temporary logging/storage of these data for viewing and/or transfer to a collection server or servers.

Provide analysis support for assessing the performance and usage of system infrastructure components and the applications that run in this environment.

It should be noted that the above characteristics are non-exhaustive and that this service may include one or more of these characteristics as well as other additional ones. A person of ordinary skill in the art will understand the various combinations of the characteristics that may be associated with this service.

Various products are available which offer system/network historical measurement data functions, with product vendors creating their own respective designs and implementations. Some of the product vendors include, for example, eHealth (Concord), Visual Uptime (Visual Networks), and Prognosis (Integrated Research). A person of ordinary skill in the art should be familiar with the various technologies that are related to system/network performance data capture as described above. Based on the disclosure provided herein, a person of ordinary skill in the art should be able to select and/or customize various currently available products for integration and use as part of the system 10 in accordance with the present invention.

8.1.3 Application Instrumentation

While the previous section discussed application monitoring from the perspective of instrumentation points located either inside the corporate firewall, or externally in the domain inhabited by end users, there is another flavor of monitoring required to complete the capture of information needed to assess the performance profile of an application. This type of monitoring, application instrumentation, requires that probe points be incorporated into the application code itself, to capture timing information that can be used to assess the performance of important sub-functions within the application. Such application-internal monitoring can most effectively be accomplished through the use of special-purpose Java classes and industry-standardized application response monitoring (ARM) calls. In one exemplary embodiment, the application instrumentation provided by the system has the following characteristics:

Capture timing information from one function point to another within the execution sequence of an application program, object or module, or between two objects or modules.

Capture counts of the number of times a section of code, object or module has been invoked.

Log the information in a pre-specified form, suitable for retrieval and processing by other products/services for retention and analysis.

It should be noted that the above characteristics are non-exhaustive and that application instrumentation may include one or more of these characteristics as well as other additional ones. A person of ordinary skill in the art will understand the various combinations of the characteristics that may be associated with application instrumentation.

Very few products exist that provide this type of application performance monitoring. In general, such facilities fall into one of the following three classes:

Vendor-provided products based on the industry-standard ARM specifications.

Vendor-provided products based on a proprietary solution.

In-house developed products created by specifying custom Java classes or other suitable language structures. This in-house code is developed as part of the application specifications.

In one exemplary embodiment where the system 10 is created using Java/JSP/J2EE constructs, either the ARM-compliant or custom Java class solution is preferred. One such product that provides this capability are MeasureWare from Hewlett-Packard. Based on the disclosure provided herein, a person of ordinary skill in the art should be able to select and/or customize various currently available products for integration and use as part of the system 10 in accordance with the present invention.

8.1.4. Measurement Data Management

The previous sections described different aspects of performance management services from the perspective of monitoring and the capture of raw historical measurement data. This data is logged and aggregated by tools that might be called analytic “point” products or “element” managers, each dealing with a particular subset of the application or infrastructure. A valuable outcome of capturing this kind of data is in the ability to aggregate it into a central information base for use in analysis and cross-correlation.

To accomplish this requires the development and use of an infrastructure to transmit the raw data from the collectors on target devices, aggregation of highly granular data through interval-summarization, and filter out less useful metrics. In addition, the data needs to be managed in a repository that can support analysis and retrieval. This can be done through the use of parsing and summarization scripts, FTP transmission of raw or summarized data and warehousing using a suitable performance database (PDB) management tool. An alternative means to aggregate and reduce the raw data is through the use of Extract, Transform and Load (ETL) technology, such as that described above. In one exemplary embodiment, performance data management provided by the system 10 has the following characteristics:

Capture raw or summarized data collected and logged by the monitoring products described in previous sections.

Aggregate raw data from collector logs using transformation to summary intervals suitable for performance analysis and usage baselining.

Transmit summarized information to a central warehousing facility. This includes data captured in the DMZ for application components, servers and other devices that reside there, as well as devices that reside in the secure zones inside the interior firewalls.

Provide assurance of data integrity (e.g., non-duplication and indication of missing elements).

Enable online access to historical summarized data, and archival retrieval of aged data.

Provide access to planning data from workstations connected to the Corporate network for analysis, baselining and reporting.

It should be noted that the above characteristics are non-exhaustive and that this service may include one or more of these characteristics as well as other additional ones. A person of ordinary skill in the art will understand the various combinations of the characteristics that may be associated with this service.

8.1.5 Historical Performance Reporting

Key features of the performance management services include the ability to report historical information about the relative health of application and software infrastructure (e.g., middleware and database software), as well as hardware infrastructure (e.g., servers and networks) components. Such historical reporting can be delivered in one or more of the following ways:

Publishing to a Web server of static reports

As the result of a query to a tool-specific repository of selected component (hardware, network or software)

As the result of a query to a consolidated planning database such as that described in a previous section

The first method of delivery listed above is usually used to provide information to management or individuals with casual interest in performance/usage statistics. The second and third methods are used by those with an interest in more detailed evaluation of performance/usage statistics. Near-real time alerting/reporting and historical reporting of alert/exception-condition trends is accomplished via the operational monitoring and alerting services discussed below.

In addition to reporting, the performance management services deliver information for use in baselining and other performance analysis and capacity planning activities. Baselining refers to developing measurements that provide a starting point for a capacity forecast or establishing a “normal” profile for system performance. Performance analysis is usually a series of steps aimed at understanding an anomaly in the behavior of an application or discovering the root cause of a persistent degradation in system performance. The key to successful performance reporting is ready access to measurement data at varying levels of granularity. In one exemplary embodiment, the historical performance reporting provided by the system 10 has the following characteristics:

A mechanism for publishing summarized performance information that is available via standard browser interface.

Access by analysts to tools and data repositories used to capture and consolidate detailed performance data across groups of monitored components (e.g., servers, network elements and applications).

Access by analysts to consolidated planning data that represent historical content sufficient for long-term planning.

Data consolidated in a manner that will support cross-correlation and root-cause analysis.

Tools to filter and statistically analyze measurement data so as to facilitate analysis.

Automation of the reporting/publishing process to the extent practical.

It should be noted that the above characteristics are non-exhaustive and that this service may include one or more of these characteristics as well as other additional ones. A person of ordinary skill in the art will understand the various combinations of the characteristics that may be associated with this service.

Various products are available which offer historical performance reporting functions, with product vendors creating their own respective designs and implementations. Such products and services include, for example, SiteScope/SiteSeer, Keynote, Prognosis, ARM monitors, eHealth and Visual Uptime. These products also provide access to summarized data for the components each is designed to monitor. Based on the disclosure provided herein, a person of ordinary skill in the art should be able to select and/or customize various currently available products for integration and use as part of the system 10 in accordance with the present invention.

Access to information summarized and consolidated for cross-correlation analysis, is provided by IT/SV and the SAS analysis/reporting tools. In addition, the SAS AppDev Studio and Internet products facilitate the creation of summary reporting on browser-accessible Web sites.

Special products may be employed to further analyze and report measurement data. An example of such a product is ProactiveNet, which uses a statistical quality-control strategy for baselining and reporting performance/usage anomalies on an exception basis.

8.1.6 Operational Monitoring, Alerting & Reporting Service

While outside of the scope of the core system architecture, operational monitoring, alerting and reporting services provided by the infrastructure and operations environment have the potential for significant interaction with performance management services. The operational monitoring, alerting and reporting service provides real-time status on a broad spectrum of application and infrastructure components. Such status might include site availability and system performance indicators, as well as other metrics that indicate the system is running as expected. This type of system monitoring also includes error checking and a health check on all applicable layers: application, web server, database, OS and hardware.

The operational monitoring, alerting and reporting service sends out alerts when certain unexpected conditions appear, such as a database failure or other unexpected critical condition. Alerts are often based on pre-defined thresholds. In addition, it provides a reporting facility so that management reports can be generated from the alert data collected during the monitoring process to reflect the system behavior.

Operational monitoring, alerting and reporting service is related to but different from the performance management service described above in the following ways:

Focus is on real-time metrics rather than collections of historical information used to support analysis and planning activities

Time span of interest relative to the captured information is much shorter (e.g., the last several hours or 1-2 days, rather than days or weeks)

Measurement sampling intervals are usually short—seconds or minutes rather than minutes or hours

Primary objective is to alert operations and support staff of problems or potential problem conditions that are occurring at the moment, rather than to detect historical patterns

Primary focus is on avoiding or troubleshooting immediate problems, rather than looking for the existence and causes of persistent anomalies

These differences arise due to the type, granularity and timeliness of data collected, as well as how the information is used.

A key output of the operational monitoring, alerting and reporting service is system-level and process-level availability monitoring, alerting and reporting. A number of methods can be applied to provide such a service.

One way is to monitor a log file generated by applications or other services. Thus, a log file from an application or service is scanned periodically. Whenever some predefined string (e.g., ‘ERR’ or ‘CRIT’) is found, an alert is issued to report the situation. This mechanism can be applied to nearly any application or service and can be used for both error and health checking.

A second way to monitor is using SNMP. If a device or service has an active SNMP agent, the monitoring service can issue an SNMP request to the agent to get the status of the application or service using a predefined Management Information Base (MIB). When a condition of interest is detected in the SNMP response, an SNMP trap can be issued, and an alert generated from this trap. This mechanism is used mainly in the lower level layers, like web servers, database, OS and hardware and is often used for health checking.

A third way to monitor is to use the predefined monitoring facilities provided by the vendor of a product being monitored. This mechanism is useful when an SNMP agent is not available and the use of a vendor-specific method is required to report errors and check health.

A fourth method is to receive information from another service that monitors for a specific condition or threshold. Once received, this information can be transformed into an appropriate alert.

In one exemplary embodiment, the operational monitoring, alerting and reporting service has the following characteristics:

Supports real-time monitoring of system environment (application and infrastructure), including both error and health checking.

Issues alerts when unexpected behavior occurs (e.g., via pagers, e-mails, or other mechanisms.)

Supports real-time reporting of system availability and performance.

Provides a user interface to set up monitors, alerts and reports.

Provides central link to other services and tools to receive and process alert-related information from these services and create effective alerts.

Provides historical reporting for alert and exception condition events.

It should be noted that the above characteristics are non-exhaustive and that this service may include one or more of these characteristics as well as other additional ones. A person of ordinary skill in the art will understand the various combinations of the characteristics that may be associated with this service.

There are many operational monitoring products in the market including some that address a limited array of components and others that cover a broad spectrum of the application and infrastructure components. One such product, for example, is the Tivoli product suite from IBM. Based on the disclosure provided herein, a person of ordinary skill in the art should be able to select and/or customize various currently available products for integration and use as part of the system 10 in accordance with the present invention.

8.2 Performance Enhancement Services

The previous section addresses performance management functions including monitoring, capturing and analyzing historical performance measurement data and creating a performance-planning database. While such measurement data can often be evaluated as it is being captured to detect predefined thresholds and generate messages to an operational monitoring and alerting system, the information is used primarily after being captured, summarized and evaluated by analysts. Consequently, this aspect of performance management provides an essentially historical perspective of performance—a perspective that is viewed primarily from outside the application environment. However, when viewed in its broadest sense, performance management includes aspects that enable the performance of an application and its associated infrastructure components to be either directly and dynamically affected during live production processing, or assessed prior to production deployment. These aspects are defined within the system architecture as performance “enhancement” services, and function as an integral part of the application and/or infrastructure. The performance enhancement services identified for the system 10 include the following: content distribution and caching, load balancing and pre-production performance assessment and deployment support, each of which is further described below.

8.2.1 Content Distribution and Caching

For web-based applications, a potentially significant component of overall response-time as perceived by the end-user is that component required to simply load a page into the browser. This page-load time is affected by factors including page density (# of images, # of text blocks, overall page size), network connection speed and geographic proximity to the server(s) delivering the page. In the world of HTTP and TCP/IP, all these factors conspire to elongate overall response time, in large part due to the number of interactions between the web server and browser required to deliver and render a page.

In addition to minimizing the size of a page and the number of components thereon, one way to improve performance (i.e., to minimize end-user response-time) is to reduce as much as possible, the time for each interaction required to deliver a page. This can be accomplished by delivering the page content to the user/browser from a high-speed store located as close a possible to the user. This type of page delivery is called content distribution and is usually implemented in conjunction with a remote caching mechanism. The notion is to pull as much of the page content as possible away from the web server, and let it be delivered by a special-purpose server located in geographical proximity to the browser. This is possible because much of the page content is static—the same each time the page is requested (e.g., a logo or standard text block). Consequently, those page components that do not change from request to request can be pre-cached for rapid delivery, without having to be generated or fetched by a central web-server or application server each time a page is requested. The special-purpose servers that provide these services are called edge servers, content distribution servers or content caching servers.

In one exemplary embodiment, the content distribution and caching provided by the system 10 has the following characteristics:

Platform separate from the web server on which to stage page content for delivery to the requesting browser.

Applications structured in such a manner as to facilitate the use of the content distribution/caching service.

Service provider that can deliver cached content from locations distributed outside of the system environment.

It should be noted that the above characteristics are non-exhaustive and that this service may include one or more of these characteristics as well as other additional ones. A person of ordinary skill in the art will understand the various combinations of the characteristics that may be associated with this service.

Examples of products providing content delivery and caching include IBM's EdgeServer technology, and services from Akamai Technologies. These services are also available from additional vendors. Based on the disclosure provided herein, a person of ordinary skill in the art should be able to select and/or customize various currently available products for integration and use as part of the system 10 in accordance with the present invention.

8.2.2 Load-Balancing

Load balancing service is required to distribute workload across a group of servers in a single location, or across several groups of servers in multiple locations. This can be accomplished in several ways using hardware, software or a combination of these. The purpose of load balancing is to provide a mechanism to minimize variations in end-user perceived performance, and to distribute work to servers in a way that makes most effective use of resources available at a given moment. For example, more work might be sent to the larger or faster servers in a group serving a given workload. Or work could be dynamically routed around a server temporarily out-of-service. If properly implemented, load balancing can be used to bring servers in and out of service without impacting application service as perceived by the users. Such an implementation will support the process of installing additional servers into an existing pool, or upgrading servers by temporarily removing them from an active group. This has the added benefit of enabling pre-production performance assessment in a production environment, just prior to production rollout (e.g., the same day), but without affecting ongoing production services.

Load-balancing functionality includes an ability to route work to servers based on metrics developed by the servers themselves. For example, if a workload is particularly dependent on having adequate CPU cycles, then CPU-busy should be available to the load-balancer for use in directing workload.

Load-balancing functionality can be implemented at the front of several tiers within the system infrastructure. For example, one group of load-balancers can be used to distribute incoming HTTP workload across a web server farm, and a second group to distribute requests from web servers across a collection of application servers. In one exemplary embodiment, the load balancing provided by the system has the following characteristics:

Resource (server) pool allocation is dynamically changeable (i.e., removing/adding servers to a group) without incurring an outage for application functionality.

Service is easy to implement, use and manage.

Service operates locally across server groups, as well as globally across geographically separated server groups.

Redundancy exists across load-balancing hardware/software to eliminate single points of failure.

Solution scales to accommodate large volumes of a variety of different types of traffic.

It should be noted that the above characteristics are non-exhaustive and that this service may include one or more of these characteristics as well as other additional ones. A person of ordinary skill in the art will understand the various combinations of the characteristics that may be associated with this service.

Various products are available which offer load balancing functions, with product vendors creating their own respective designs and implementations. Such products include, for example, the Arrowpoint technology from Cisco Systems, Resonate Central and Global Dispatch, and EdgeServer technology from IBM. Based on the disclosure provided herein, a person of ordinary skill in the art should be able to select and/or customize various currently available products for integration and use as part of the system 10 in accordance with the present invention.

In an exemplary implementation, the system 10 as described above is utilized by a credit card association, such as, Visa, to help facilitate processing of credit card transactions. It should be understood that the system 10 provides a platform and associated functionality upon which various types of applications relating to credit card transaction processing can be implemented and executed. For example, an application system that is designed to handle credit card payment dispute resolution can be developed to function on top of the system 10.

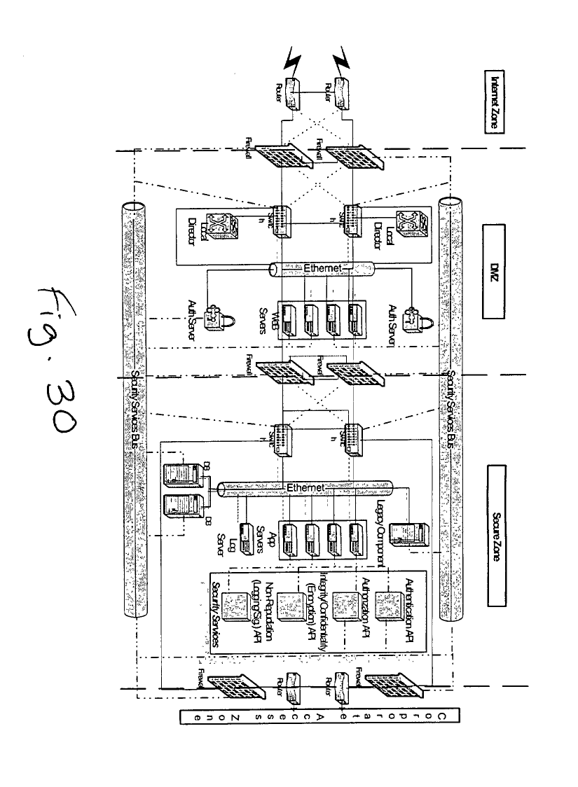

Referring to FIG. 30, there is shown a simplified block diagram illustrating an exemplary physical implementation of the system 10. Based on the disclosure provided herein, a person of ordinary skill in the art will know of other ways and/or methods to implement the system in accordance with the present invention.

Furthermore, in an exemplary embodiment, one or more components of the system 10 are implemented, in either a modular or integrated manner, using control logic and/or modules written in computer software. It should be noted, however, that based on the disclosure provided herein, a person of ordinary skill in the art will know of other ways and/or methods to implement the system in accordance with the present invention in software, hardware or a combination of both.

Moreover, it should also be noted that the various components of the system 10 as described above may each be implemented using either independently developed components or commercial products that have been customized in accordance with the present invention. Based on the disclosure provided herein, a person of ordinary skill in the art will know how to select the appropriate design and implementation choice to implement the present invention.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference for all purposes in their entirety.

What is claimed is:

1. A system for delivering a plurality of services to handle credit card transaction processing, comprising:
a component configured to provide a presentation framework;
a component configured to implement a plurality of application components;
a component configured to implement a plurality of application servers;
a component configured to provide asset management;
a component configured to provide data management;
a component configured to provide enterprise application integration;
a component configured to provide auxiliary services management;
a component configured to provide performance management; and
control logic configured to facilitate communications amongst the various components.
